(19) United States
(12) Patent Application Publication
(10) Pub. No.: US 2024/0401718 A1
(43) Pub. Date: Dec. 5, 2024

(54) Apparatus and Method for Transporting and Laying Pipelines

(71) Applicant: JT Lewellen, Houston, TX (US)

(72) Inventor: JT Lewellen, Houston, TX (US)

(21) Appl. No.: 18/676,437

(22) Filed: May 28, 2024

Related U.S. Application Data
(63) Continuation-in-part of application No. 18/662,880, filed on May 13, 2024.
Application No. 18/662,880 is a continuation-in-part of application No. 18/111,877, filed on Feb. 20, 2023, now abandoned.
Application No. 18/111,877 is a continuation-in-part of application No. 17/557,054, filed on Dec. 21, 2021, now Pat. No. 11,598,450.
(60) Provisional application No. 63/469,441, filed on May 28, 2023.
(60) Provisional application No. 63/134,513, filed on Jan. 6, 2021.
(60) Provisional application No. 63/463,863, filed on May 3, 2023.

(51) Int. Cl. F16L 1/036; F16L 1/06; F16L 1/10

(52) U.S. Cl. CPC F16L 1/036; F16L 1/065; F16L 1/10

(57) ABSTRACT

Apparatus and method for transporting and laying pipe segments or sections directly in a ditch dug for underground pipeline installation, minimizing use and size of right-of-way adjacent the ditch. The apparatus has a mobile unit with support configured to align weight of the pipe segments or sections with the longitudinal central axis of the mobile unit. Caterpillar tracks carry and move the apparatus, which can be controlled remotely. The apparatuses transport and lay pipe segments by cooperating in tandem formation while maintaining alignment of the weight of the cable with the longitudinal central axis of each of the mobile units.

### RELATED APPLICATIONS

This application claims priority from U.S. Provisional Patent Application No. 63/469,441, filed May 28, 2023, pending, and is is a continuation in part of U.S. Pat. No. 18,662,880, filed May 13, 2024, pending, which claims priority from U.S. Provisional Patent Application No. 63/463,863, filed May 11, 2023, now expired, and is a continuation in part of U.S. Pat. No. 18,111,877, filed Feb. 20, 2023, pending, which is a continuation in part of U.S. Pat. No. 11,598,459, issued Mar. 7, 2023, and which claims the benefit of U.S. Provisional Patent Application Ser. No. 63/134,513, filed Jan. 6, 2021, now expired, and all of which are incorporated herein by reference to every extent that may be allowed.

### BACKGROUND

### 1. Field

The present invention relates to pipelines generally comprised of mid-sized and large-sized pipes with relatively thick and/or coated-walls usually comprised of metal, metal alloys, or heavy synthetic polymers, that often extend for at least a mile and are known to extend for hundreds of miles. That is, the present invention relates to pipelines for carrying industrial and commercial fluids, such as, for example, hydrocarbons such as oil and oil derivatives, petro-chemicals and other chemical products, and hydrocarbon natural gas and other gases and slurries, which according to their application are often designated respectively as oil pipelines, chemical pipelines, gas pipelines, and slurry pipelines. The present invention is not directed to water mains, aquaducts, or irrigation pipelines, which are usually comprised of smaller-sized pipes and often with plastic walls, for transporting water or sewage in association with public works, or for irrigating agricultural crops and pastures for grazing animals.

More particularly, the present invention relates to installation of such medium and larger pipelines and methods and apparatuses used for that installation. Most specifically, the present invention relates to pipe laying apparatuses and methods for transporting and laying pipe and pipe segments to comprise such medium or larger pipelines for carrying industrial and commercial fluids, particularly oil, gas, and chemicals.

### 2. Description of Related Art

Pipelines for distributing oil, natural gas, and chemical fluids or slurries, for commercial or industrial use and/or distribution, are comprised of many lengths of individual pipes welded together into pipe segments, which in turn are further welded together to make pipeline sections which are further welded together to make the pipeline.

The pipes and often the pipe segments are typically made off-site, transported to a pipeline installation site, assembled into longer pipeline sections on site, and then moved to and installed at a desired location for the pipeline. Such location can be within a ditch or trench, above ground, or beneath a body of water such as a river, stream, or lake. Longer pipeline sections can also or alternatively be joined together to complete the pipeline after the pipeline sections are in place or are about to be positioned in place, to complete the pipeline assembly and installation.

Pipelines vary in diameter depending on what they are intended to transport. Crude oil pipelines tend to have the largest diameters, typically ranging from about 16 inches to about 42 inches. The TransAlaska oil pipeline which runs 800 miles from Prudhoe Bay to Valdez has a 48 inch diameter. More recently built pipelines transporting heavy crude oil from Western Canada into the United States and toward the Gulf Coast have had pipes of 32 inches or more in diameter. Pipelines that transport hydrocarbon gas liquid tend to be smaller with diameters ranging from about 12 to about 20 inches. Pipelines that transport refined products such as gasoline and diesel tend to be the smallest with diameters ranging from about 6 to about 8 inches.

Currently, an average pipeline has a diameter of over about 26 inches in diameter. The Interstate Natural Gas Association of America has projected that in the future, until about 2035, average diameters for oil, gas and natural gas pipelines are expected to typically be, respectively, 27.6 inches for oil, 29.2 inches for natural gas, and 18.3 inches for natural gas. Pipelines for oil products such as petrochemicals are expected to average 18.3 inches in the near future. <https://www.ingaa.org/File.aspx?id=34658>, last visited 01/14/2023.

Currently, oil, gas, and chemical pipelines are typically buried at depths of about 3 to 6 feet, and are comprised of many pipes welded together. A typical pipe is about 20 feet in length and a typical pipe segment, which is also called a pipe joint, is about 40 feet in length. The pipelines themselves typically extend at least a mile and often can extend for many miles, even hundreds or sometimes thousands of miles.

Not the focus of the present invention are: water mains comprised of concrete; smaller branch water lines comprised of plastics having an interior diameter of about one-half inch up to about 6 inches for providing service to individual homes, offices, buildings, and businesses; and irrigation lines typically having an interior diameter of about ⅛ inch to about 1 inch, Such smaller pipelines and water pipelines are generally easier to handle, and do not involve the same installation procedures or problems as seen with larger oil, gas and chemical pipelines.

The method of laying pipelines comprised of medium and/or large pipes or pipe segments for oil, gas and chemical pipelines in general consists of building pipes, distributing the pipes along their intended path, and assembling the distribution line by connecting the pipes to one another, usually by welding. Many difficulties are encountered in constructing the distribution line in view of the larger size and consequent heavier weight of the pipes that are employed, and the environmental, geographical and weather constraints that must be overcome. Large and heavy equipment is traditionally considered necessary to move and lay the pipes and pipe segments in place.

The traditional method used to assemble medium and larger diameter pipelines intended to carry and oil, gas and related chemicals, or similar commercial and industrial fluids, comprises transporting the pipes or pipe segments of appropriate length for each use to the assembly site where they are placed forming a line (in an arrangement approximately parallel along the course of the pipeline path, typically along the side of a trench for holding the pipe to form the desired pipeline). Side booms then are traditionally needed and used to lower the pipes into the trench usually section by section after the pipes have been welded into segments and/or sections.

Side booms are large tractor type vehicles which carry pipe or pipe segments at the end of a boom or arm. The boom, or arm, extends off a lateral side of the vehicle while counterweights attached to the opposite lateral side of the vehicle offset the weight of the pipe segment and the boom. Caution is required to avoid tipping the side boom over and to avoid dropping the pipe segment from too great a height and damaging the pipe segment. Often, human skilled crew must be dangerously positioned near the side booms to help direct the pipe segment off the side booms. The procedure usually requires numerous side booms and is time consuming and costly and can be hazardous for the crew.

Because new pipelines continue to be needed, and existing pipelines require repair, extension, or replacement, there remains interest in improving the pipe laying process to reduce costs and potential hazards and harms to workers and the environment, and to lessen the time spent in completing the process. Improved methods have been offered and tried, but numerous costly side booms have continued to be needed in laying midsize and large size pipe sections.

### SUMMARY

The present invention provides an apparatus for transporting and laying a pipe, pipe segment, or pipe section for a pipeline. The apparatus comprises a mobile platform having a longitudinal central axis and a front end and a rear end for receiving and unloading the pipe, pipe segment or pipe section onto and off of the mobile platform. Said front end and rear end of the mobile platform can be used interchangeably—or vise versa.

The mobile platform of the apparatus of the invention has at least one support configured to align a weight of the pipe, pipe segment, or pipe section with the longitudinal central axis of the mobile platform. That alignment should occur upon the mobile platform's receiving the pipe, pipe segment or pipe section and should continue or be maintained during the holding, transporting and unloading of the pipe, pipe segment, or pipe section at a delivery location.

The apparatus also has at least one pipe holder with a low-friction surface extending from or associated with at least one support for facilitating the receiving, holding, transporting and unloading of said pipe, pipe segment, or pipe section on the mobile platform. In one embodiment, the low-friction surface can be provided with rollers, which may in still another embodiment have lubricant thereon.

In one embodiment, the pipe holder comprises a cage with rollers on at least one side for facilitating movement of pipe into, within and out of the cage. In another embodiment, the pipe holder comprises a pair of treads or rollers with tread-like surfaces which sandwich the pipe and roll to facilitate movement of the pipe, pipe segment, or pipe section between the treads. Such pipe movement facilitate loading and unloading of the pipe, pipe segment or pipe section onto and off of the apparatus.

Caterpillar track(s) or tank treads carry and move the apparatus of the invention and an engine or motor is configured to drive the track or tank treads. This movement can be controlled remotely. That is, the apparatus has a programmable controller that allows remote control of the caterpillar track(s) or tank treads, the engine, the mobile platform, the support(s), and the pipe holder(s) of the apparatus. Similar “dummy” or “auxiliary” engineless units can be pulled or pushed by one or more apparatuses of the invention working or operating in tandem for carrying longer lengths of pipe, pipe segment or pipe section than a single unit can support or carry.

One embodiment of the apparatus of the invention further comprises an optional ramp for attaching to an end (front or back) of the mobile platform to aid the uploading or unloading of the pipe, pipe segment or pipe section.

At least one support on the mobile platform is preferably adjustable such that a height position of that support is adjustable with respect to the mobile platform and the pipe holder. In one embodiment having multiple supports that are adjustable or extendable, the adjustments can be made such that the pipe or pipe holder tilts to enable gravity to aid unloading of the pipe, pipe segment or pipe section.

The present invention further provides methods of using the apparatuses of the invention for transporting and laying pipe, pipe segments and pipe sections at a delivery location. Such delivery location can be the intended pipeline location itself, above ground, in a ditch, or underground that is accessed in cooperation with directional drilling equipment. Alternatively, such delivery location can be near such intended pipeline location for providing ready access of pipe, pipe segments or pipe sections for constructing the pipeline.

The apparatuses of the invention can be positioned in tandem formation for cooperation in receiving, moving, and unloading pipes, pipe segments, and pipe sections. At such times, alignment of the weight of the pipe, pipe segment, or pipe section with the longitudinal central axis of each of the mobile platforms is maintained.

According to one embodiment of the method of the invention, instead of lowering pipe segments for the pipeline into the trench from the right-of-way as in prior art methods, the method of the invention uses apparatuses of the invention to move down into the trench to lay the pipe, pipe segments of pipe sections for the pipeline into place. The site is staged at the beginning of the trench (or trench section of interest) to completely assemble pipe into pipe segments or sections on an assembly-line of stations that are set up for each stage of the pipeline assembly process. After the pipe, pipe segments, or pipe sections are pushed through the stations, the pipe segments, or pipe sections are loaded onto and travel through the apparatuses of the invention that are waiting in the trench to guide the pipe segments or sections into position. The pipe segments or pipe sections are gently lowered into the trench as the apparatuses slide out from the pipe segments or pipe sections. After the pipe segments or pipe sections have been lowered into place, the site equipment and apparatuses are moved to the next location for further laying of pipe segments or pipe sections for the pipeline, and the method is repeated.

### BRIEF DESCRIPTION OF THE DRAWINGS

The invention can better be understood by reference to the following detailed description when read in conjunction with the accompanying drawings, which are not drawn to scale but are intended to be illustrative, wherein:

FIG. 1 is an illustration showing trucks on a right-of-way adjacent a trench where a pipeline is to be laid using the traditional method of laying a pipeline, which is prior art.

FIG. 2 is an illustration showing pipe segments being laid into a trench for holding a pipeline using side booms positioned on the right-of-way adjacent the trench for lowering the pipe segments into the trench for forming the pipeline, according to the traditional method of laying a pipeline, which is prior art.

FIG. 3 is a prior art photograph showing side booms on a right-of-way adjacent a trench laying pipe segments in the trench for forming a pipeline, according to the traditional method of laying a pipeline.

FIG. 4 is an illustration of a first embodiment of the apparatus of the invention shown from an end view having an enclosed, protective encasing pipe holder supported on the mobile platform of the apparatus of the invention.

FIG. 5 is an illustration of a second or alternative embodiment of the apparatus of the invention shown from a side view having multiple 360 degree “O”-shaped or similarly closed cradle pipe holders each extending from respective multiple supports on the mobile platform of the apparatus of the invention, and showing an optional removable ramp in place for use.

FIG. 6 is an illustration of a third or alternative embodiment of the apparatus of the invention shown from an end view having at least one open “C”-shaped cradle pipe holder extending from a support on the mobile platform of the apparatus of the invention.

FIG. 7 is an illustration of the top view of the embodiment of the apparatus shown in FIG. 6, further showing multiple open “C”-shaped cradle pipe holders and an optional ramp in place for use.

FIG. 8 is an illustration of an alternative or fourth embodiment of the apparatus of the invention shown from an end view having at least one horseshoe shaped cradle hanging from a gantry extending over at least a portion of the mobile platform and extending from at least one support on the mobile platform of the apparatus of the invention.

FIG. 9 is a schematic of the embodiments of the apparatuses of the invention shown respectively in FIGS. 5, 19, and 10, illustrating positioning apparatuses of the invention in tandem with each other in one configuration for use in methods of the invention.

FIG. 10 is a side view of the fifth or alternative embodiment of the apparatus of the present invention, having a cage encasement type pipe holder supported on the mobile platform of the apparatus of the invention, for transporting and laying pipe or pipe segments or pipe sections for a pipeline, according to a method of the present invention.

FIG. 11 is an end view of the apparatus shown in FIG. 10, particularly showing the rollers on the sides, not shown in FIG. 10.

FIG. 12 is a perspective view of a sixth or another alternative embodiment of the apparatus of the invention, which like the embodiment in FIGS. 10 and 11 has a cage encasement-type pipe holder supported on the mobile platform of the apparatus of the invention, but which unlike the embodiment in FIGS. 10 and 11, has rollers only on the sides and bottom and not at the top of the cage, for holding and transporting pipe or cable.

FIG. 13 is a side view of the embodiment of the apparatus of the invention shown in FIG. 12.

FIG. 14 is an end view of the embodiment of the apparatus of the invention shown in FIGS. 12 and 13.

FIG. 15 is a perspective view of the cage which holds the pipe for transport on the apparatus shown in FIGS. 12-14.

FIG. 16 is a side view of the cage shown in FIG. 15.

FIG. 17 is an end view of the cage shown in FIGS. 15 and 16.

FIG. 18 is a blown apart view of cage shown in FIGS. 15-17.

FIG. 19 is a side view of an alternative, engineless, embodiment of the apparatus of the invention shown in FIG. 5 having multiple 360 degree “O”-shaped or similarly closed pipe holders each extending from respective multiple supports on the mobile unit of the apparatus of the invention, but where the mobile unit moves across ground on a sled and is pulled or pushed by another apparatus of the invention or an auxiliary apparatus.

FIG. 20 is a seventh or another alternative embodiment of the apparatus of the invention where the pipe holder is comprised of a pair of large rollers in a form akin to tank treads which sandwich the pipe, pipe segment, or pipe section between them for transport atop the mobile unit of the apparatus of the invention.

FIG. 21 is an illustration of one embodiment of the three apparatuses of the invention (also shown in FIG. 5) working in tandem to hold and carry or transport to a delivery location for pipeline placement a pipe section after receipt of the pipe section from a pipe tensioner or pipe pusher in one example application of the method of the invention.

FIG. 22 is an illustration of the three apparatuses of the invention in the application shown in FIG. 21 unloading the pipe section at the delivery location.

FIG. 23 is an illustration of one embodiment of the multiple apparatuses of the invention (also shown in FIG. 5) working in tandem to carry and transport a pipe section to a delivery location for placement through directional drilling under a body of water in another example application of the method of the invention.

FIG. 24 is a bird's eye or overhead view of the scene in FIG. 23.

FIG. 25 is an illustration of another embodiment of multiple apparatuses of the invention (also shown in FIG. 6) working in tandem to hold and carry or transport to a delivery location for pipeline placement a pipe or pipe segment after receipt of the pipe or pipe segment from a pipe tensioner or pipe pusher in another example application of the method of the invention.

FIG. 26 is an illustration of the multiple apparatuses of the invention in the example shown in FIG. 25 unloading the pipe section at the delivery location.

FIG. 27 is a schematic of an assembly line of stations for preparing pipes for pipe segments to form a pipeline for installation into a trench for holding the pipeline, according to the method of the invention.

FIG. 28 is a schematic of one embodiment of the apparatus of the invention lined up in multiples along the assembly line of stations of FIG. 4 in preparation for receiving the pipe segments from the last station in the assembly line and carrying the pipe segments to the trench for laying the pipeline, according to the method of the present invention.

FIG. 29 is another view of the stations and apparatuses of the invention, shown in FIG. 28.

FIG. 30 is another view of the stations and apparatuses of the invention, shown in FIGS. 28 and 29.

FIG. 31 is a schematic of the apparatuses of the invention proceeding into the trench for receiving and laying pipe segments for forming a pipeline according to the method of the invention.

FIG. 32 is another view of apparatuses of the invention proceeding further into the trench shown in FIG. 31.

FIG. 33 is still another view of apparatuses of the invention proceeding into and lining up in the trench shown in FIG. 32.

FIG. 34 is a view of more apparatuses of the invention lining up in the trench shown in FIGS. 31, 32, and 33.

FIG. 35 is a schematic of the apparatuses of FIG. 34 raising up for receiving pipe segments for laying in the trench.

FIG. 36 is a schematic of the pipe segments being delivered to the apparatuses of the invention in the trench shown in FIG. 35.

FIG. 37 is a schematic of the pipe segments being delivered to apparatuses of the invention in the trench shown in FIG. 36 but later in time.

FIG. 38 is a schematic of the pipe segments being delivered to apparatuses of the invention in the trench shown in FIG. 37 but still later in time.

FIG. 39 is a schematic of the pipe segments being carried by apparatuses of the invention in the trench for placement into the trench for forming a pipeline, according to a method of the invention.

FIG. 40 is a schematic of the pipe segments being carried by apparatuses of the invention in the trench and being placed in the trench for forming a pipeline, according to a method of the invention.

FIG. 41 is closer view of the schematic of FIG. 40.

FIG. 42 is a schematic of the pipe segments being carried by apparatuses of the invention in the trench and being placed in the trench for forming a pipeline as in FIG. 41, according to the method of the invention, but later in time when the placement of the pipe segments in the trench is nearly complete, according to a method of the invention.

FIG. 43 is a schematic showing return of the apparatuses of the invention to stations to repeat the method of pipeline placement according to a method of the invention, after placement of pipe segments in a trench according to a method of the invention as shown in FIGS. 31-42, to extend the pipeline further.

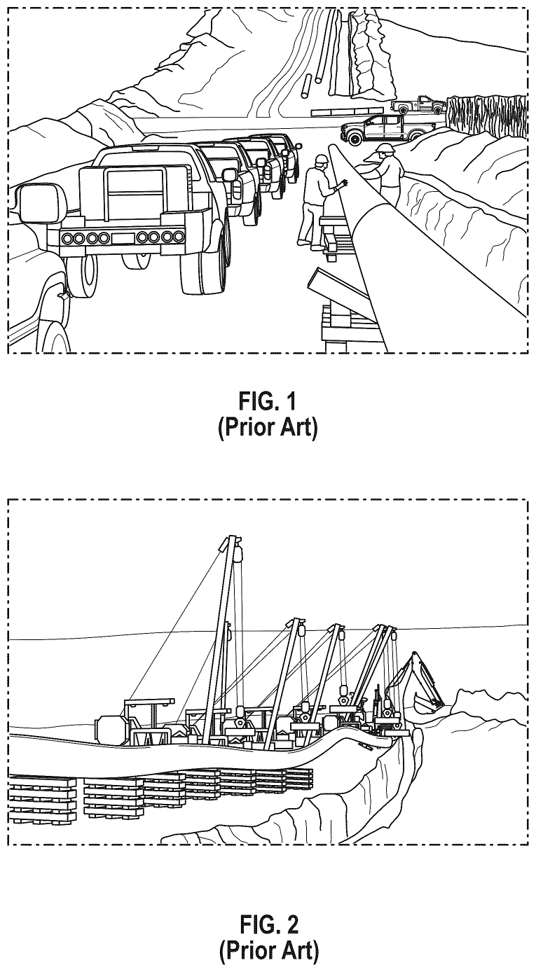

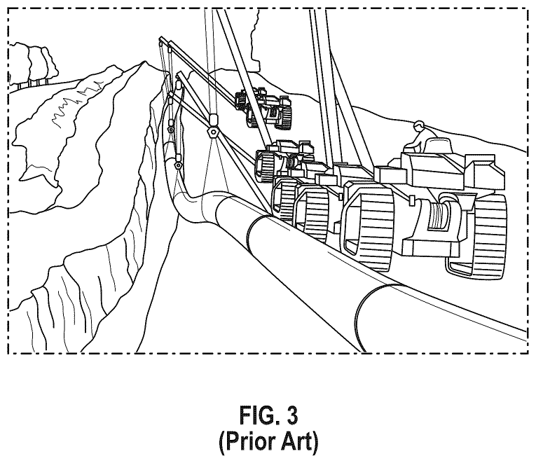

### DETAILED DESCRIPTION

The present invention provides an apparatus for use in transporting pipe, pipe segment, or pipe section, and laying pipe, pipe segment, or pipe section in a trench, beside a trench or at or otherwise above ground level, or near or under a body or water such as in association with directional or horizontal subterranean drilling. The present invention further comprises a method using apparatus(es) of the invention for transporting and laying pipe, pipe segment, or pipe section in a trench, for installing such pipe, pipe segment, or pipe section underground.

The apparatus of the invention can be remotely controlled, and can require relatively little or no need for use of a right-of-way or easement beyond the amount where the pipe, pipe segment, or pipe section is to be buried underground for a pipeline, and thereby minimizes environmental interference from the installation. In use, an apparatus of the invention can receive, lift or lower a pipe, pipe segment, or pipe section, carry such pipe, pipe segment, or pipe section to and/or hold it at a desired location, and then either transfer the pipe, pipe segment, or pipe section to another apparatus of the invention (whether it comprises a mobile unit or an auxillary unit) or lower the pipe, pipe segment, or pipe section into place at the desired location for underground installation. For such transfer or delivery, the apparatus of the invention can be caused to employ controlled assistance from gravity, enabling the apparatus to function efficiently.

The apparatus of the present invention is preferably sized to be no more than about twelve inches wider than and preferably no wider than, or even up to about three to six inches less than, the width of the pipe, pipe segment, or pipe section the apparatus is intended to carry. In one embodiment the width of the apparatus of the present invention is adjustable or expandable. Sizing of the apparatus of the invention related to the size pipe, pipe segment, or pipe section that the apparatus is intended to carry enables the apparatus of the invention to be able to fit in a ditch or trench or other location in which the pipe, pipe segment, or pipe section is to be placed for underground installation.

Considering the diameters of pipe, pipe segment, or pipe section in existence today for underground placement, typically 12 inches and 24 inches in diameter, the apparatus of the invention is provided in one embodiment in two different sizes, one having a width of about twelve inches, and one having a width of about twenty four inches, These sizes are believed to provide general utility for most of the pipe, pipe segment, or pipe sections contemplated for underground placement currently. Wider pipe might be used for pipe groupings of more than about two or three pipe segments or sections and a larger apparatus of the invention could be used accordingly.

With reference to the Figures, illustrations of the apparatus of the invention in different embodiments and uses or applications are provided, showing different pipe holders for holding a pipe, pipe segment, or pipe section on the mobile unit of the apparatus of the invention. In these illustrative examples, the same reference numerals may be used in more than one Figure. This reuse of a reference numeral in different Figures represents the same element in the different Figures, even though the Figures may illustrate different embodiments of the apparatus of the invention, indicating that such embodiments, albeit different, have some common or like elements.

Referring to the Figures, depicting multiple embodiments of the apparatus of the invention (for illustration and not drawn to scale), the apparatus has caterpillar track or tank treads 12 for ease of movement of the apparatus on soil 13 as is commonly present in a pipe, pipe segment, or pipe section environment for underground installation, which is typically a ditch or trench 15 or right away adjacent the ditch or trench which may or may not have soil piled on it from digging of such ditch or trench. Wheels or skids or sleds could be substituted for the caterpillar track or tank treads 12, for use on harder ground in the environment such as, for example, pavement, or ice and/or mud respectively.

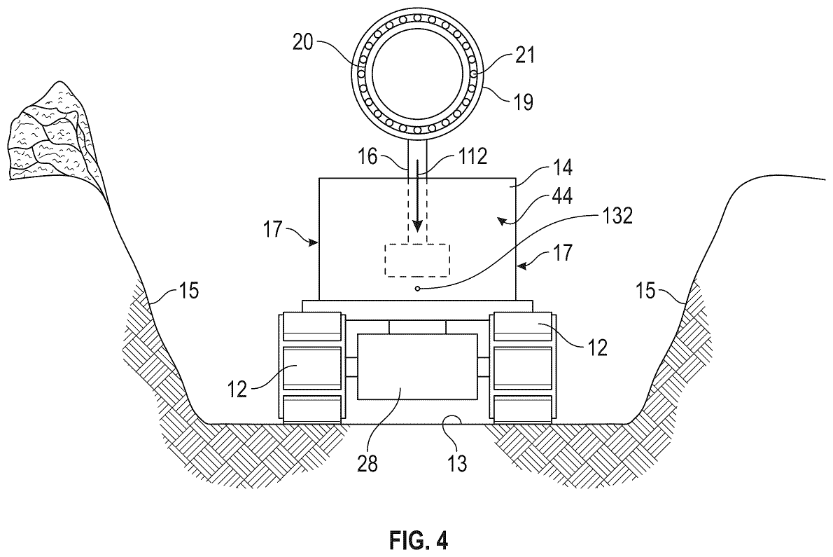

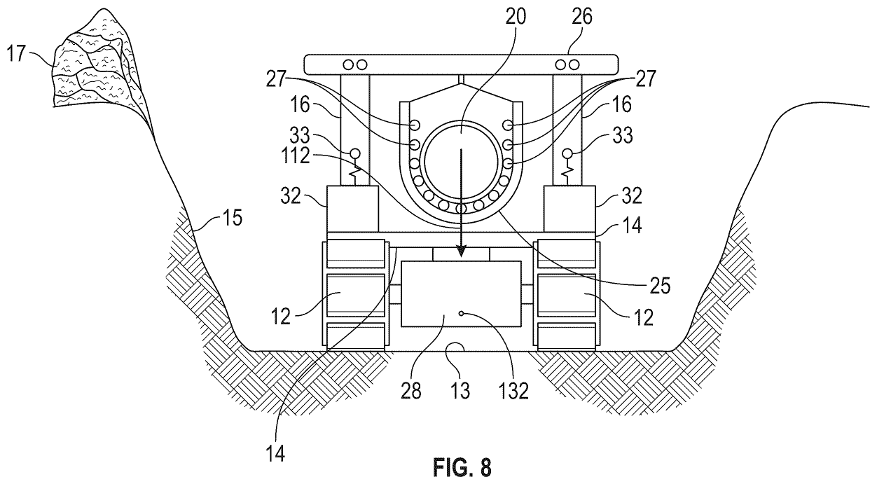

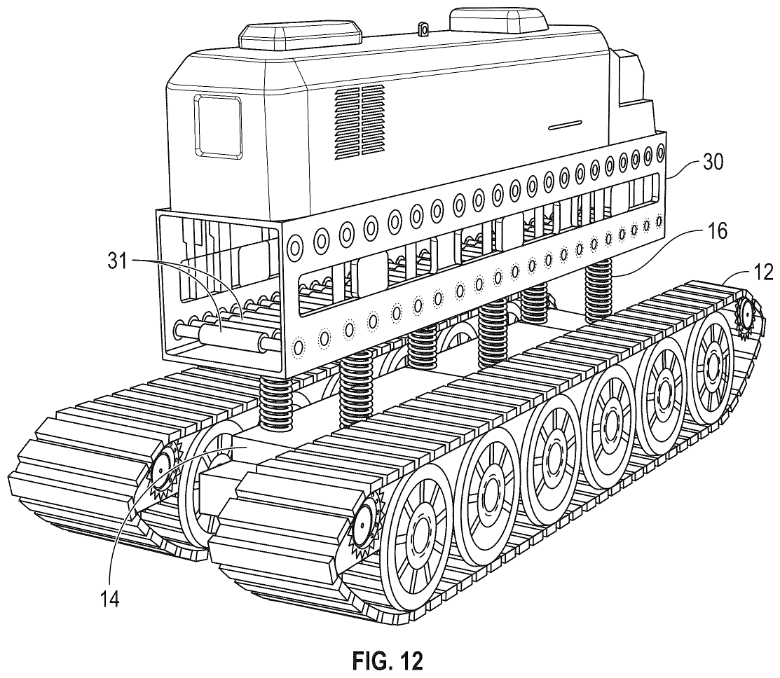

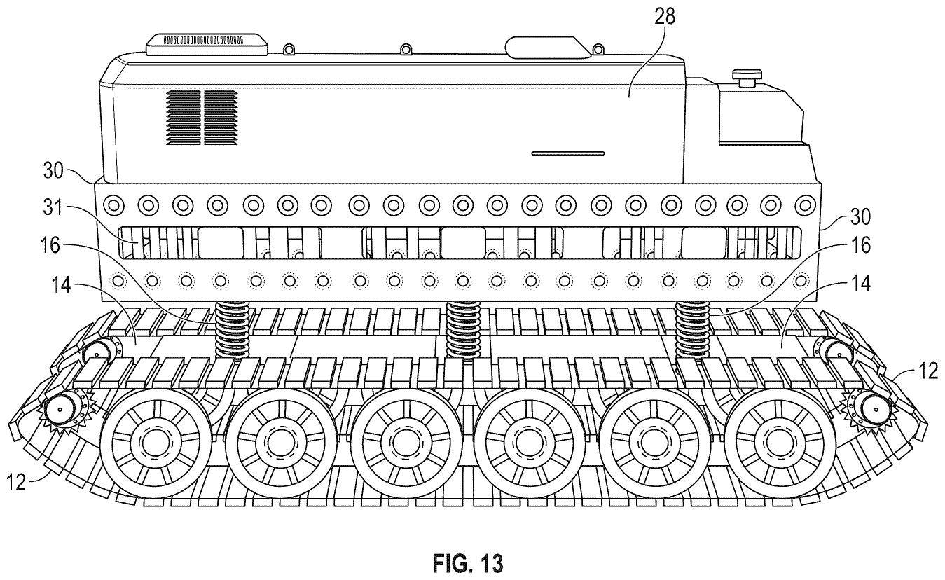

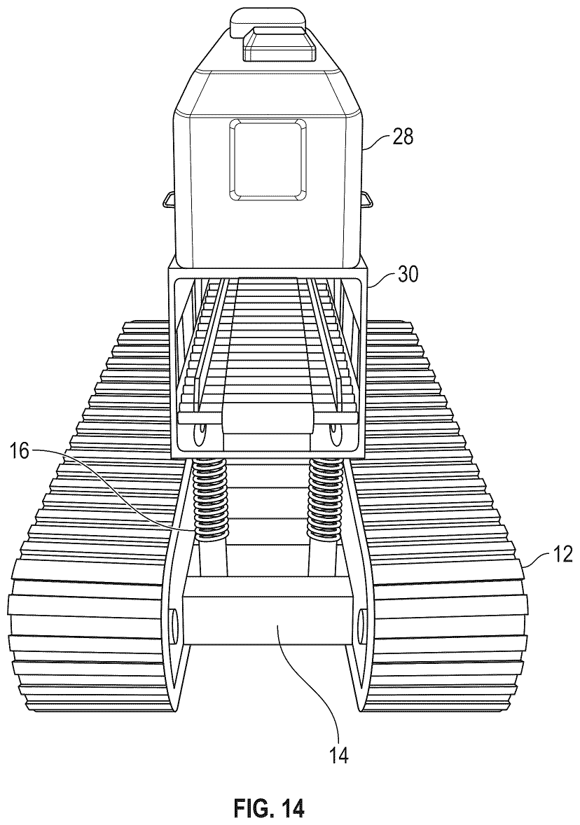

The caterpillar track or tank treads 12 carry a mobile unit 14 of the apparatus of the invention, which has at least one support 16 extending therefrom for supporting the pipe, pipe segment, or pipe section 20. As used herein, the term “mobile unit” is understood to include a single unit or multiple units associated together to have the effect of a single unit for purposes of supporting the pipe, pipe segment, or pipe section 20 on the apparatus of the invention. In some embodiments, the mobile unit 14 will comprise a housing and/or plate above the tank treads. See, for example, FIGS. 4-8. In some other embodiments, the mobile unit 14 will comprise a structure between the tank treads, and may be in some embodiments so integrated with the support 16 that the mobile unit 14 and support 16 seem to be or function as one structure. See, for example, FIGS. 12-14. Some auxiliary units of the apparatus of the invention, which are substantially like the mobile units except lacking a motor or engine to independently drive the unit, may be substituted for mobile units so long as the auxiliary units are associated in tandem with mobile units capable of pulling or pushing the auxiliary units.

Support 16 has associated with it or extending from it a pipe holder 24, which holds and supports the pipe, pipe segment, or pipe section on the apparatus for receipt or uploading, transport, delivery and unloading and/or offloading of the pipe, pipe segment, or pipe section 20. The pipe holder 24 is configured to align weight 112 of pipe, pipe segment, or pipe section 20, with the longitudinal central axis 132 of the apparatus of the invention as the apparatus receives and/or uploads, holds, transports, and transfers or unloads and/or offloads a pipe, pipe segment, or pipe section. The longitudinal central axis 132 can be defined as the linear axis positioned equidistant from the two lateral sides 17 of the mobile unit 14. The weight 112 of the pipe, pipe segment, or pipe section is advantageously not carried to the side of apparatus of the invention. Weight 112 is represented in the Figures with arrows. See FIGS. 4, 5, 6, 8, 12.

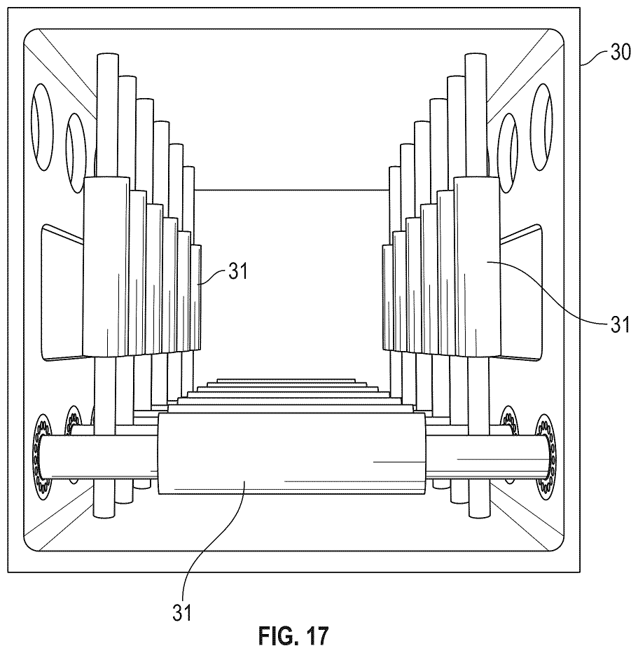

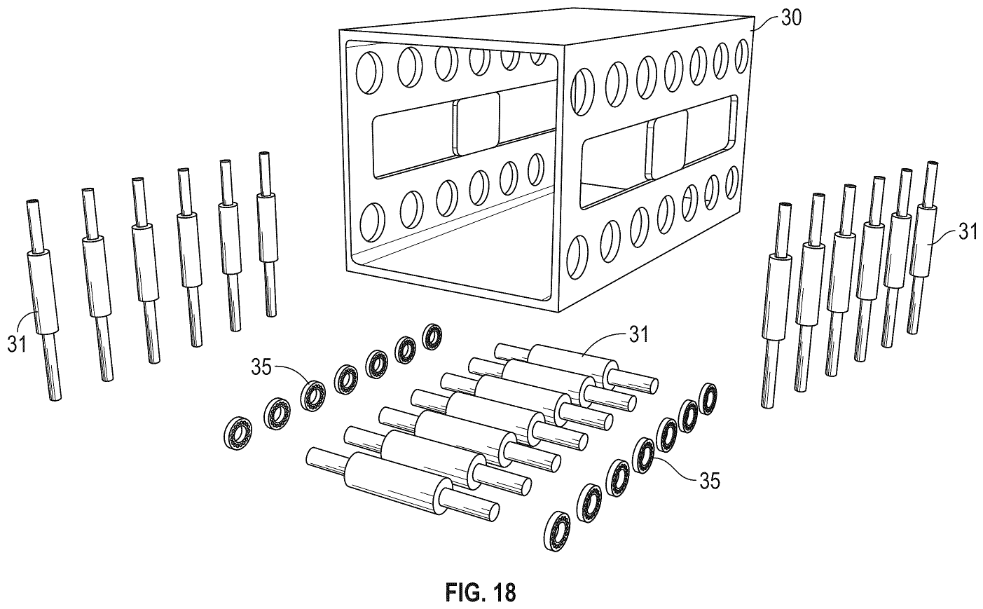

The pipe holder 24 on the apparatus of the invention has the functions discussed above, even though it can be different in different embodiments of the apparatus of the invention as illustrated in the FIGS. 4-20 and discussed below, referring to different embodiments of pipe holder 19, 22, 24, 25, 29, 30, and 32 in FIGS. 4, 5, 6, 8, 10, 12 and 20 respectively.

In one embodiment, the pipe holder is comprised of an encasement for pipe, pipe segment, or pipe section 20, having in one embodiment a length slightly less than or about the same as the pipe, pipe segment, or pipe section 20, with interior rollers 31 about at least a portion of its interior circumference or perimeter. Such encasement can be, for example, a larger diameter encasing pipe holder 19, a horseshoe-shaped cradle pipe holder 25 hanging from at least one gantry or overhanging support 26 which can extend directly from mobile unit 14 or from another support extending from mobile unit 14, or a cage pipe holder 29 or 30, as shown in FIGS. 4, 8, 10, and 12. This encasement-type of pipe holder 19, 25-26, 29, and 30 receives, protects, holds, and supports, the pipe, pipe segment, or pipe section 20 while the interior rollers 31 help facilitate movement of the pipe, pipe segment, or pipe section 20 during receipt or uploading and unloading the pipe, pipe segment, or pipe section 20. In one embodiment, such encasement type of pipe holder can be removed and replaced with a different sized diameter but otherwise like or similar encasement type pipe holder so that the apparatus can be readily adapted for holding different diameter pipes, pipe segments, or pipe sections.

The cage pipe holders 29 and 30 are square or rectangular, rather than shaped like the pipe they encase or “house” as with the encasing pipe holder 19, but the cage pipe holders 29 and 30 are also used to receive and hold the pipe, pipe segment, or pipe section with cylindrical or longitudinal interior rollers 31 on the interior sides of the cage above and/or below the pipe, pipe segment, or pipe section in the cage as shown in FIGS. 10-14. These cylindrical or longitudinal rollers 31 also allow or provide for movement of the pipe, pipe segment, or pipe section onto and off of the apparatus. Cage 29 is supported on the mobile unit 14 of the apparatus of the invention with adjustable supports.

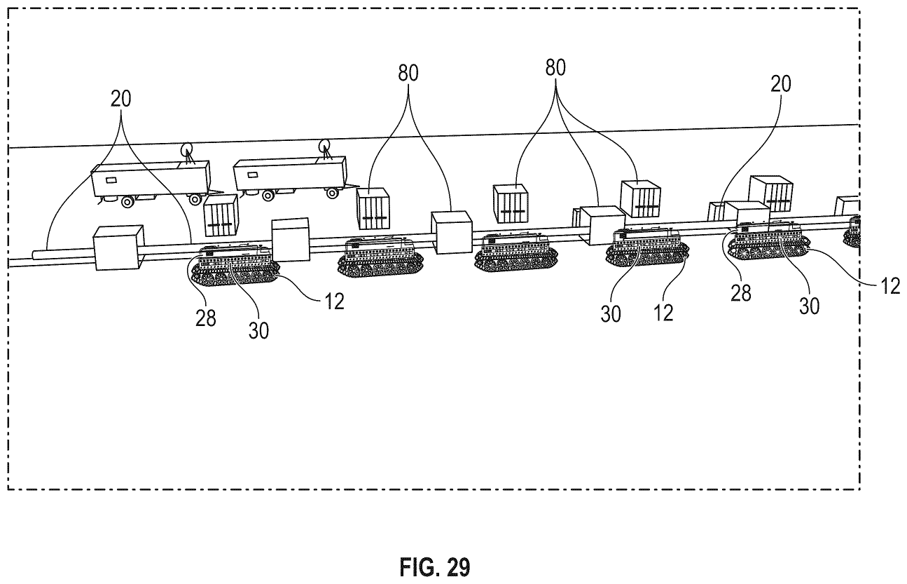

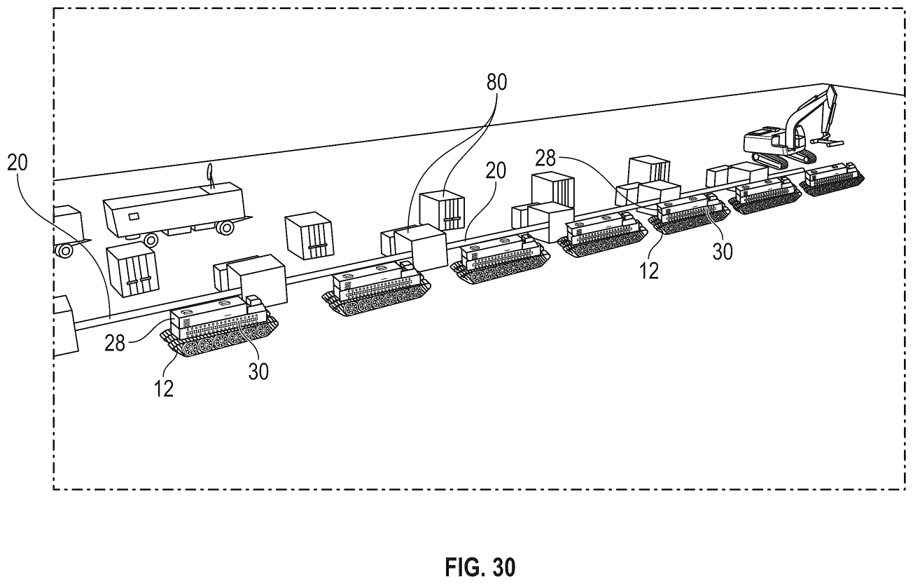

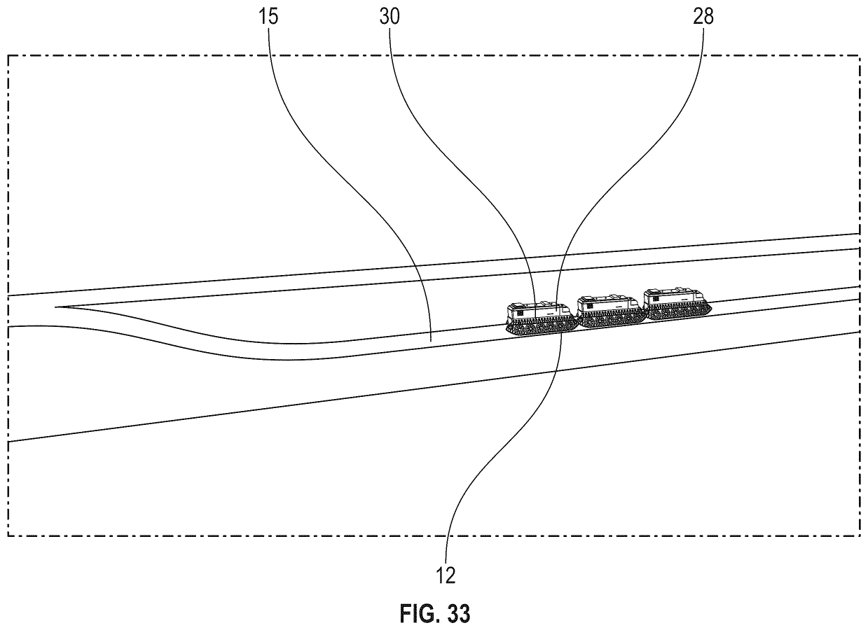

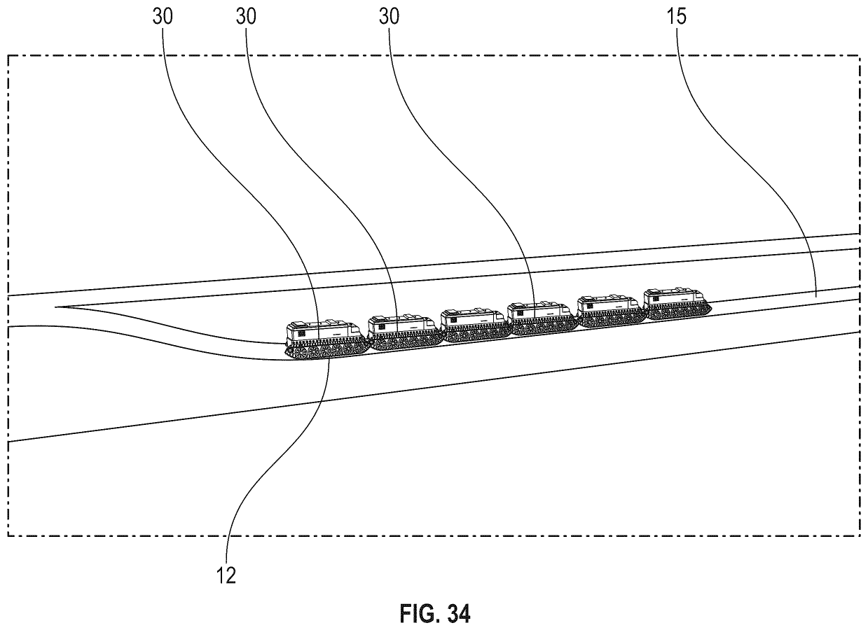

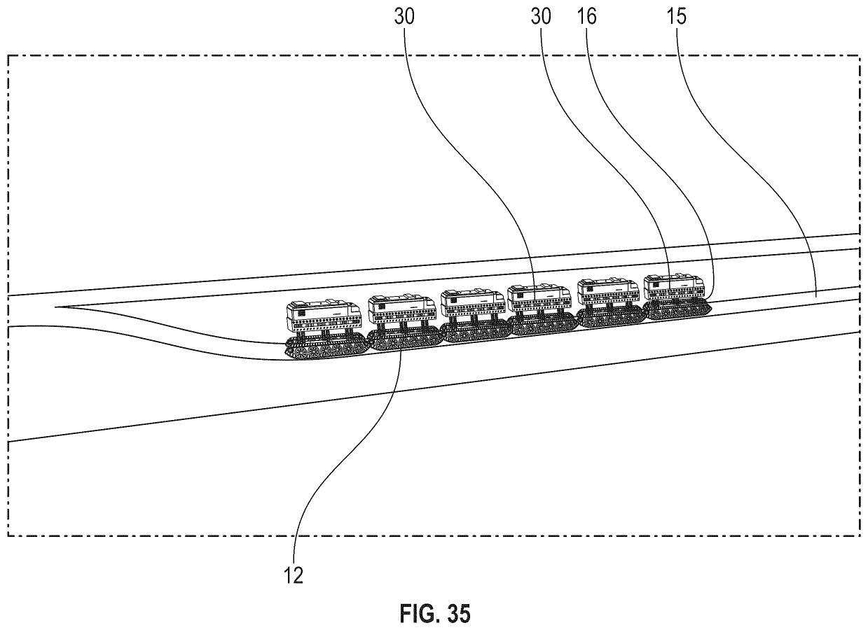

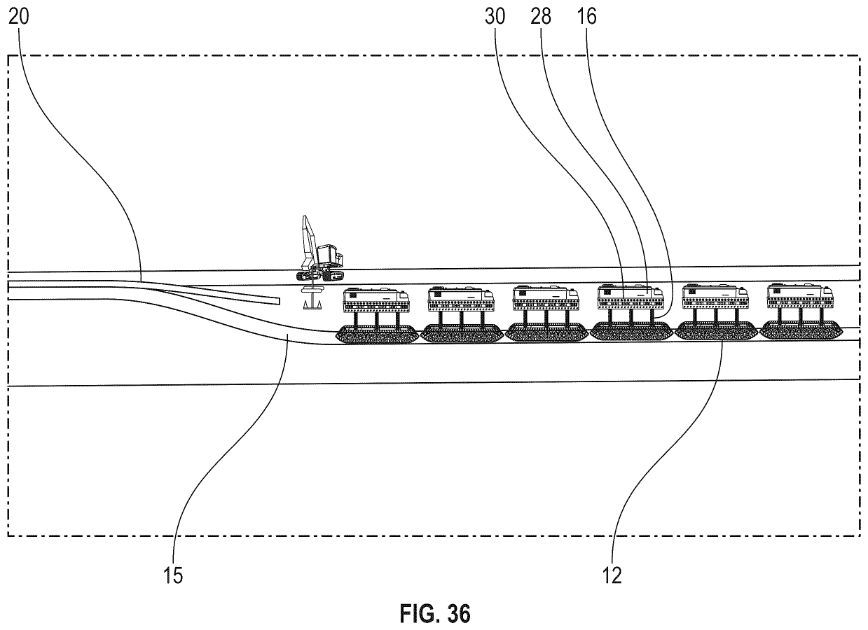

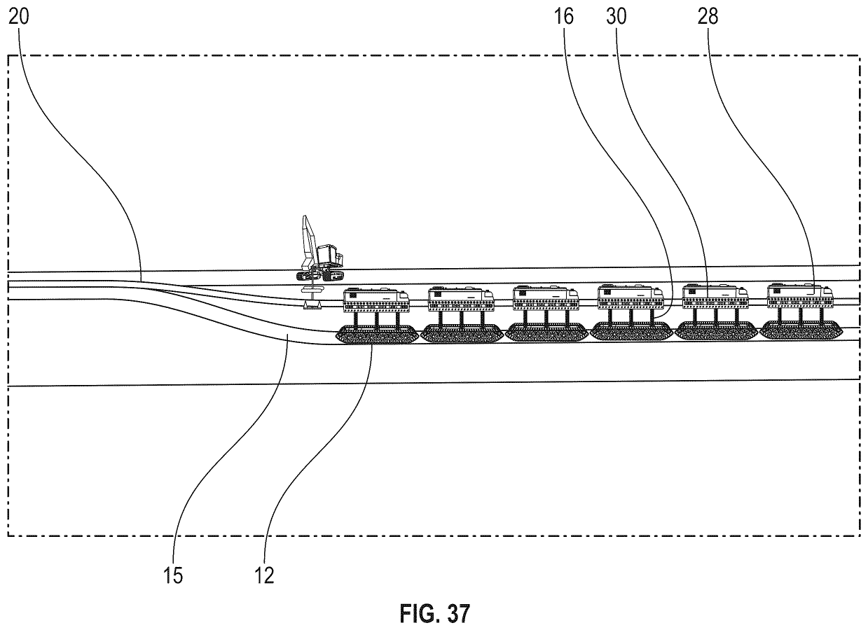

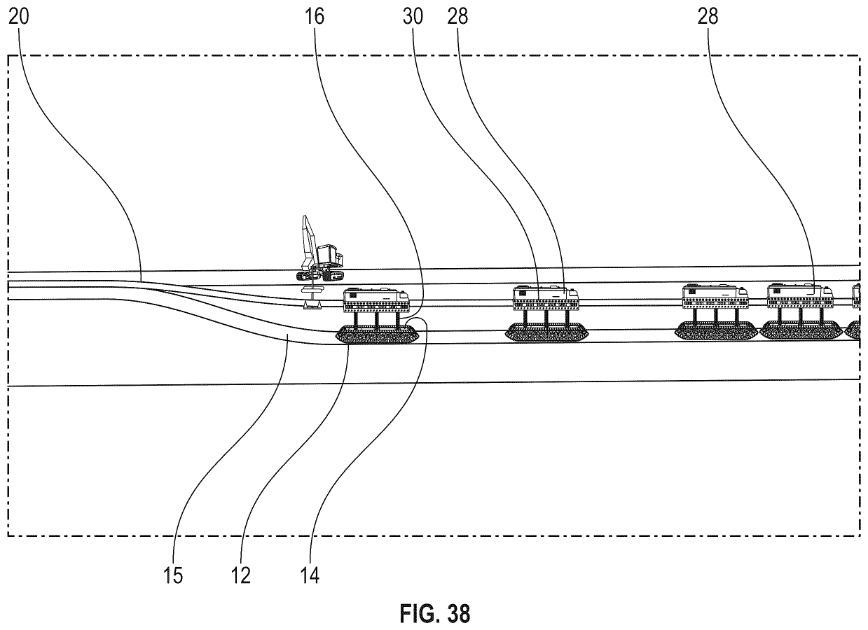

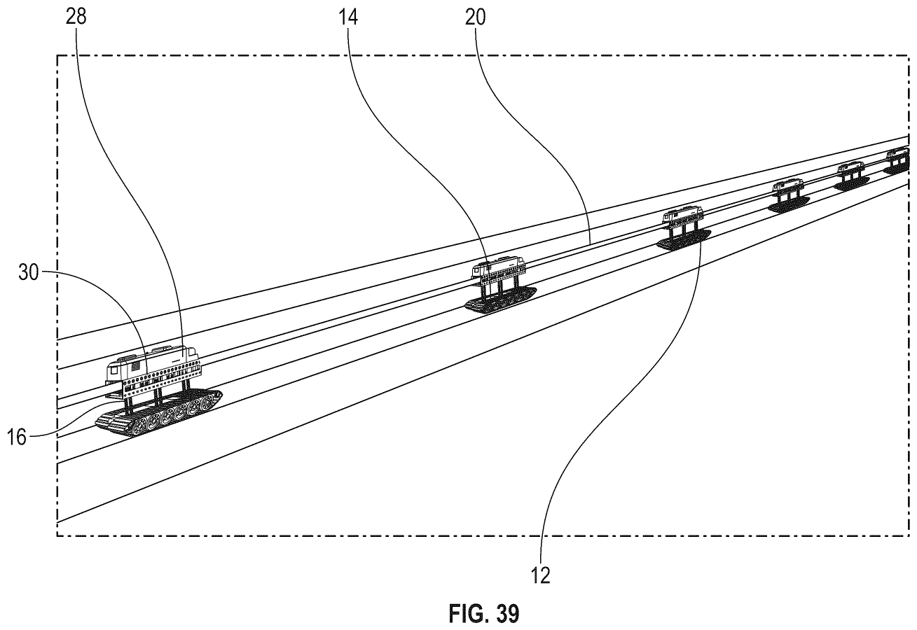

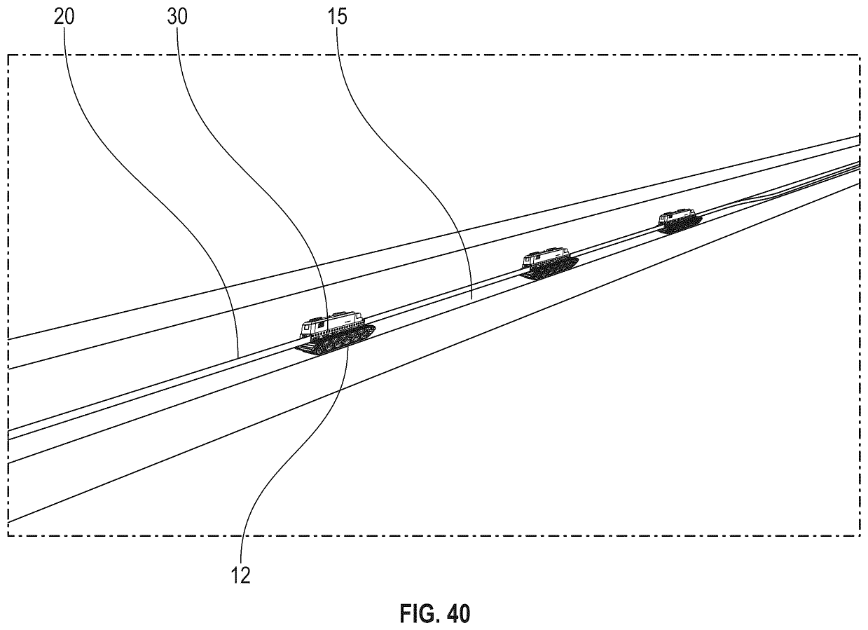

In another similar embodiment shown in FIGS. 12-14, and 28-42, a square or rectangular cage 30 is used to receive and hold the pipe, pipe segment, or pipe section with cylindrical or longitudinal interior rollers 31 on the interior sides of the cage and below the pipe, pipe segment, or pipe section in the cage 30 as shown in FIGS. 12, 14, 15, 17, and 18, but not with cylindrical or longitudinal interior rollers 31 above the pipe, pipe segment, or pipe section as for Cage 29. Cage 30 is also supported on the mobile unit 14 of the apparatus of the invention with supports 16 as shown FIGS. 12-14. These supports 16 can also raise and lower and/or tilt cage 30, as discussed further below.

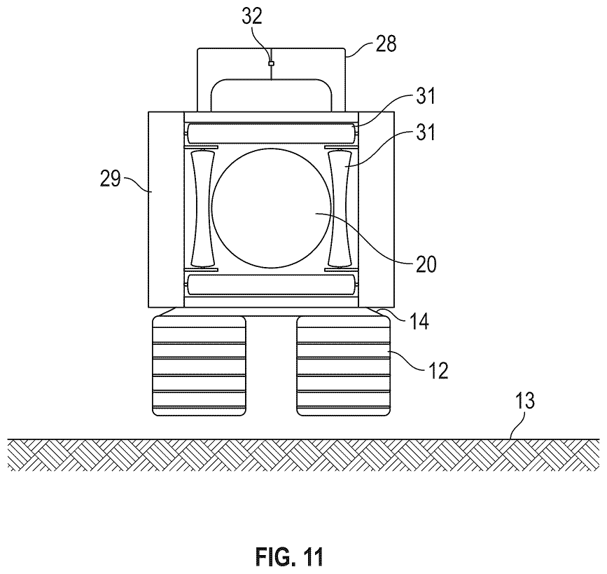

In the embodiment of the apparatus of the invention having a cage pipe holder 29, shown in FIGS. 10-11, and the apparatus of the invention having a cage pipe holder 30, as shown in FIGS. 12-14, the support 16 (or other suspension system) supporting the cage 29 or 30 is connected to the apparatus base or mobile unit 14, which enables the pipe, pipe segment or pipe section 20 to be carried low on the apparatus, and the cage 29 or 30 lifted for receiving the pipe, pipe segment, or pipe section 20.

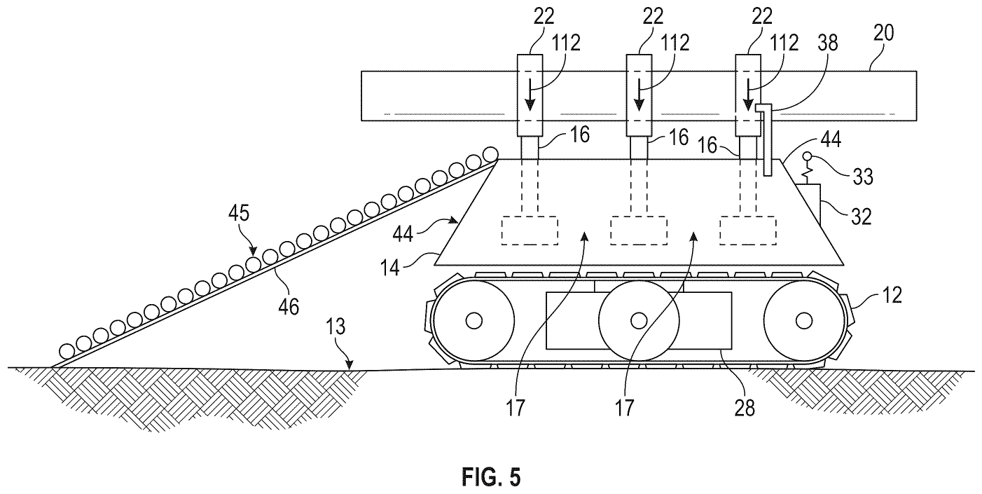

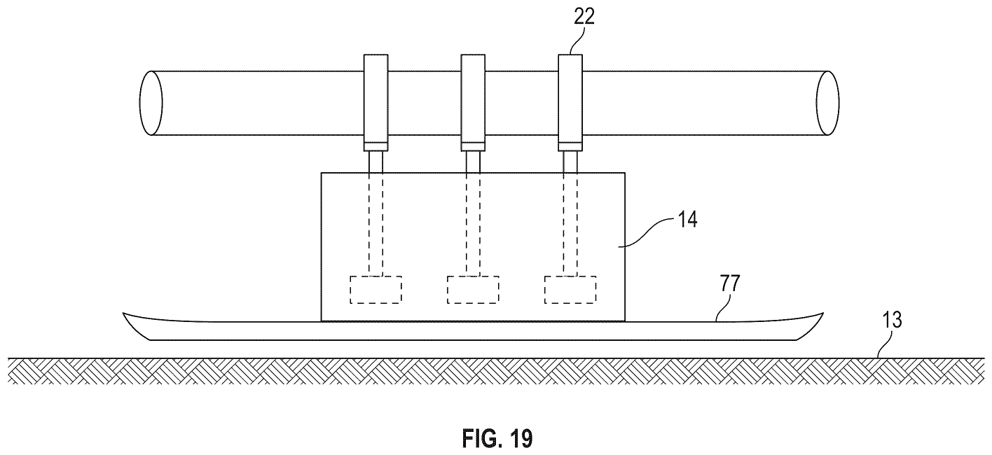

In an alternative embodiment, the pipe holder is comprised of at least one 360 degree “O” shaped cradle 22 or similarly closed cradle such as a “D” (turned sideways)-cradle for example, and one embodiment of the apparatus of the invention has multiple such O-shaped cradle pipe, pipe segment, or pipe section holders 22 as shown for example in FIG. 5 (which in an end view can look like or similar to the encasing pipe holder 19 shown in FIG. 4. In the embodiment, the mobile unit 14 crosses ground on caterpillar or tank treads 12. However, in a similar embodiment, shown in FIG. 19, the mobile unit 14 crosses ground on a sled 77, and in the embodiment shown, is pulled or pushed by another apparatus or an auxiliary apparatus, as this embodiment does not have an engine.

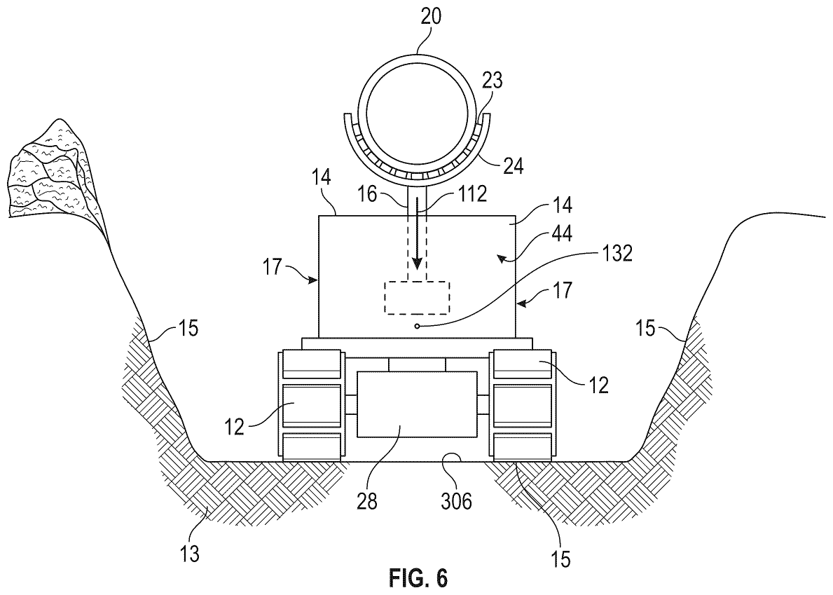

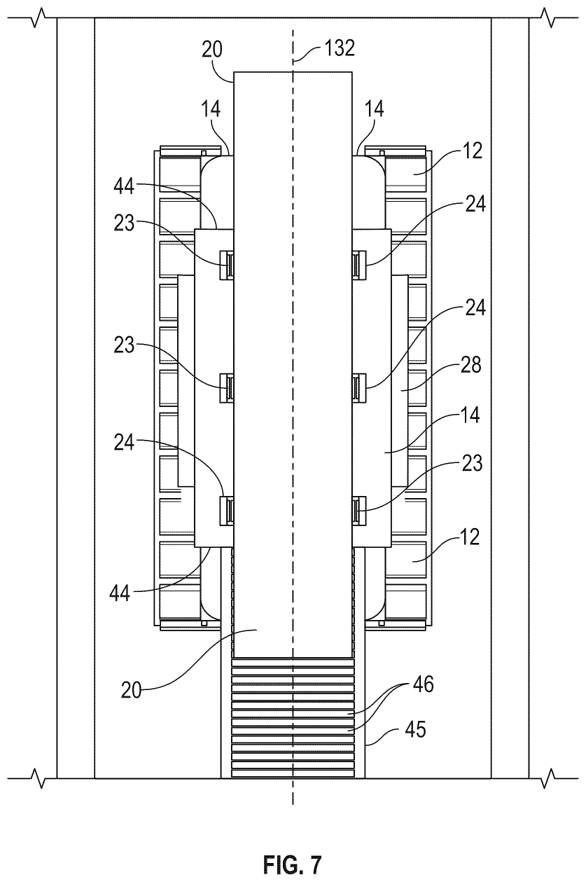

In another alternative embodiment, the pipe holder is comprised of at least one open cup or C-shaped cradle 24 (to conform to a portion of the generally cylindrical shape of the pipe, pipe segment, or pipe section 20), with rollers 23, as shown for example in FIG. 6. One embodiment of the apparatus of the invention has multiple such cup or C-shaped cradles 24 with rollers 23 as shown in FIG. 7.

FIGS. 5, 7, 9, 19, and 21-26, show two or three such pipe holders (and respectively two or three corresponding supports 16) for illustrative purposes. Fewer or more such pipe holders and supports could be used with adequate success. Similarly, one or multiple supports 16 could be used for the encasing pipe holder 19 shown in FIG. 4, or the cage pipe holders 29 and 30 shown respectively in FIGS. 10-15. Multiple encasing, or cage, pipe holders could alternatively be used.

While the Figures illustrate a one-to-one correspondence of pipe holder to support on the mobile unit, it is also envisioned that alternatively multiple supports could support one pipe holder, and further alternatively that multiple pipe holders could be supported by one support.

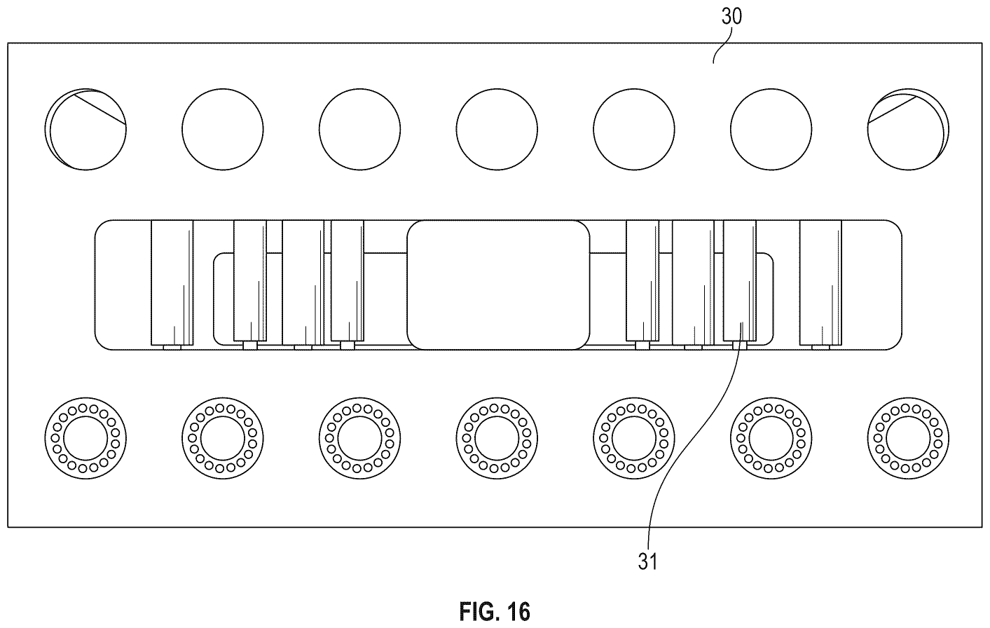

In some of the embodiments of the apparatus of the invention, each support 16 is extensible or extendable, for example, via hydraulics or hydraulic cylinders. Because the pipe holder (19, 22, 24, 25, 29, 30, and 78 respectively in the Figures) is attached, directly or indirectly, to the distal end of the support 16, the distance of the pipe holder from the mobile unit 14 can be adjustable. Thus, for example, if desired, support 16 can be raised to receive a pipe, pipe segment, or pipe section 20, onto the pipe holder(s), or can be lowered to provide a low profile for transport. See, e.g., FIGS. 21-16 and 28-42.

When multiple supports 16 are used, the supports 16 should preferably be independently extensible or extendable so that they can be extended in different amounts—one support 16 with respect to the other support 16—when desired so as to cause the pipe, pipe segment, or pipe section to tilt as opposed to be held parallel to the mobile unit. Such tilt, as will be discussed further below, can be used to facilitate offloading of the pipe, pipe segment, or pipe section from the mobile unit in certain applications or uses of the apparatus.

When only one support 16 is used, or when multiple supports 16 are desired to extend the same amount one with respect to the other, such support 16 can be adapted to itself tilt or to have associated or interrelated with it a tiltable or tilt-causing attachment so that the support 16 can cause the pipe, pipe segment, or pipe section to tilt as opposed to being held parallel to the mobile unit when desired, or the mobile unit itself can be adapted to lift, lower, and/or tilt. During transport, however, the pipe, pipe segment, or pipe section will usually preferably be held parallel to the mobile unit.

A level sensor, associated with controller 32, senses the horizontal position of mobile unit 14 as the apparatus traverses the ground. If the ground is uneven, the level sensor can send signals to the one or more supports 16 and adjust the extension length of each support such that a pipe, pipe segment, or pipe section or pipe, pipe segment, or pipe section segment or pipe, pipe segment, or pipe section section supported by a pipe, pipe segment, or pipe section holder on or attached to or extending from or integrated with the support stays horizontally level despite uneven terrain that the apparatus is traversing.

In an alternative embodiment, the mobile unit 14 is itself extensible or extendable and can tilt (at either end 44 of the apparatus rather than at either lateral side 17 of the apparatus) to raise or lower the pipe, pipe segment, or pipe section holder(s) and their support(s) 16. In this embodiment, the level sensor associated with controller 32 can send signals to the mobile unit 14 to raise, lower, or tilt the mobile unit 14 and cause the pipe holder(s) and pipe, pipe segment, or pipe section 20 to be raised or lowered or tilted respectively thereby.

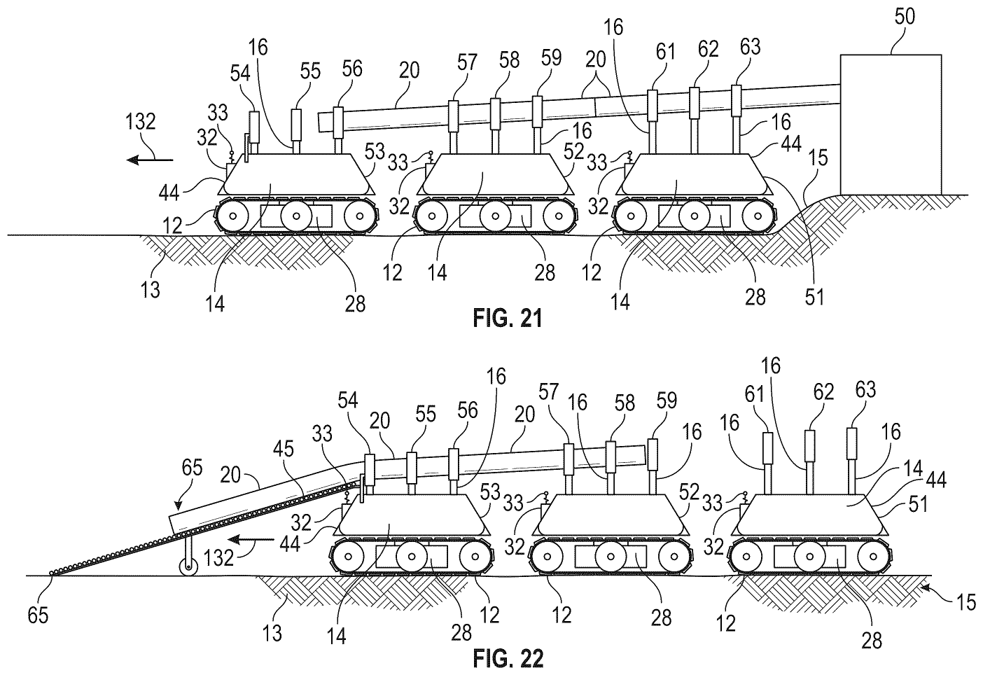

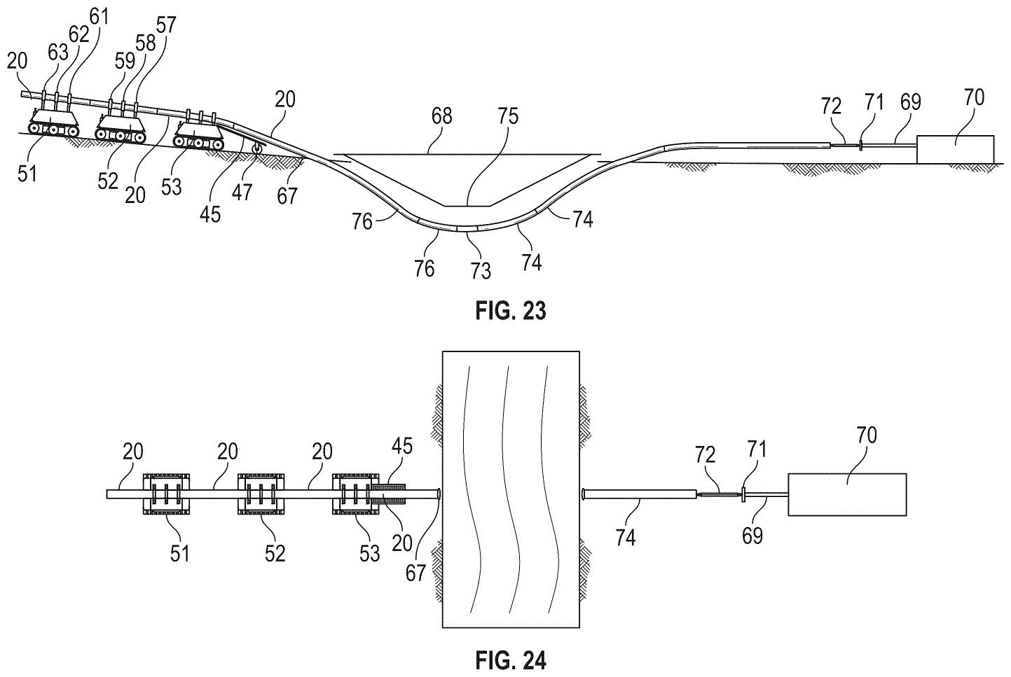

Each pipe holder can include a low-friction surface, such as rollers 21, 23, 27, 31, and tread-type roller 79, as shown in FIGS. 4, 6, 8, 10-12, 14-18, and 20, respectively, or lubrication in order to facilitate movement of pipe, pipe segment, or pipe section 20, through or onto the pipe holder for receipt or uploading of the pipe, pipe segment, or pipe section 20, onto the mobile unit 14 and for transfer and unloading and/or offloading of the pipe, pipe segment, or pipe section 20, from the mobile unit of the apparatus to another apparatus, as shown for example in FIG. 21, or to the location of pipe, pipe segment, or pipe section delivery, such as respectively in the bottom of a trench as shown in FIG. 22, or on a pipe, pipe segment, or pipe section collection site or supply unit for use in directional or horizontal drilling, as shown for example with respect to laying pipe, pipe segment or pipe section under a riverbed in FIGS. 23 and 24.

As a result of such low friction surface of the pipe holder, the pipe, pipe segment, or pipe section 20 is free to move relative to the pipe, pipe segment, or pipe section holder and to the mobile unit 14 unless restrained in some manner. Brake 38, as shown in FIG. 2, provides one example for such restraint. In this embodiment, brake 38, attached to mobile unit 14 and/or to at least one of the pipe holders, secures pipe, pipe segment, or pipe section 20, relative to mobile unit 14. When brake 38 is engaged, pipe, pipe segment, or pipe section 20, is no longer free to move relative to the pipe holder and mobile unit 14.

The apparatus of the invention can optionally include a ramp 45, as shown for example in FIGS. 5, 7, and 22-24, which is preferably attachable at either end 44 of the apparatus of the invention, that is the front or the back of the apparatus, which in most embodiments of the apparatus of the invention will look similar, as shown in FIGS. 5, 9, 10, 13, and 20-24. Also in most embodiments of the apparatus of the invention, the front end and the back end of the apparatus can be used interchangeably or vice versa.

Unless specifically indicated otherwise herein, reference to an “end” of the apparatus of the invention means either end—the front end or the back end and vice versa. Thus end 44 in FIG. 5 is at either the front or the back of the embodiment of the apparatus of the invention shown in FIG. 5, and the end views of the embodiments of the apparatuses of the invention shown in FIGS. 4, 6, 8, 11, and 14 can be either the front end or the back end of the apparatuses and vice versa.

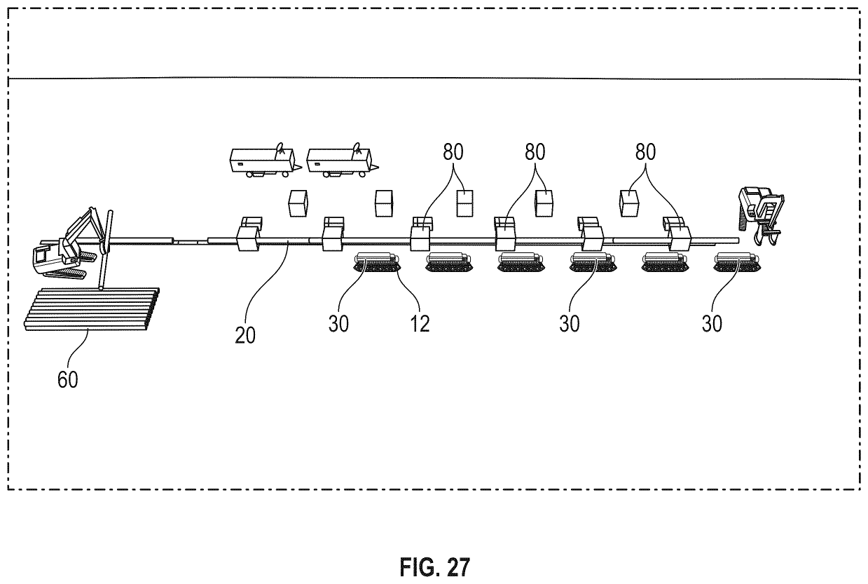

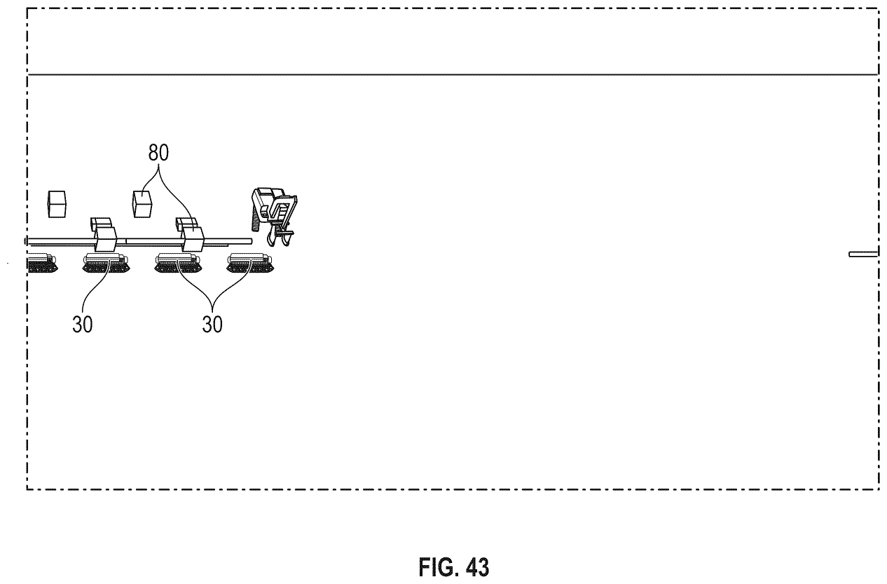

When attached to an end 44 of the apparatus for use, and particularly to the mobile unit 14 at said end 44, ramp 45 extends from said mobile unit 14 to the location that the pipe, pipe segment, or pipe section 20, on the mobile unit 14 is to be unloaded and/or offloaded and laid or deposited, such as, for non-limiting examples, the floor of a trench or ditch for pipe placement as shown in FIGS. 22, 42, and 43, or on a pipe, pipe segment, or pipe section collection site such as in FIG. 27, or for use with directional drilling near a feed site 67 such as shown in FIG. 23 where directional drilling is used to place a pipe, pipe segment, or pipe section under a river 68.

When unloading or offloading pipe, pipe segment, or pipe section 20 from mobile unit 14, pipe, pipe segment, or pipe section 20 slides down ramp 45 until said pipe, pipe segment, or pipe section 20 is in contact with the surface of the desired deposit location. Ramp 45 includes a low-friction surface. The low-friction surface of ramp 45 can be lubricated or can include slides or rollers 46, as shown for example in FIGS. 5 and 7. For example, rollers 46 can include ball bearings, spherical rollers, or cylindrical shaped rollers. Cylindrical shaped rollers can have a diameter in the range of, for example, 1 to 12 inches. Larger or smaller diameters are also contemplated. The low-friction surface of ramp 45 can further include bumpers or a V-shaped surface to direct the pipe, pipe segment, or pipe section or pipe, pipe segment, or pipe section segment 45 to the longitudinal middle of ramp 45.

Ramp 45 can also include a wheel 47 attached to the underside of ramp 45 as shown in FIG. 22. The wheel 47 supports or helps support the weight of the ramp 45 and the pipe, pipe segment, or pipe section 20, when the pipe, pipe segment, or pipe section 20, is offloading from the mobile unit 14 down ramp 45. Such wheel 47 is sized such that it vertically positions the end of the ramp 45 proximate the deposit location for the pipe, pipe segment, or pipe section 20, such as for example, a floor of a trench or ditch, or the feed site location 67 (FIG. 23) for use with pipe, pipe segment, or pipe section line placement employing directional drilling under a river 68 or body of water as shown in FIGS. 23 and 24. The wheel 47 can optionally include a wiper (not shown). The wiper would rub the wheel to remove mud, clay, or dirt that could possibly collect on the wheel.

Although it is contemplated that ramp 45, which is optional, can be used for unloading or offloading pipe, pipe segment, or pipe section 20 from mobile unit 14, ramp 45 can in one embodiment also be used for uploading or receiving pipe, pipe segment, for holding and transporting the pipe, pipe segment, or pipe section 20 on mobile unit 14.

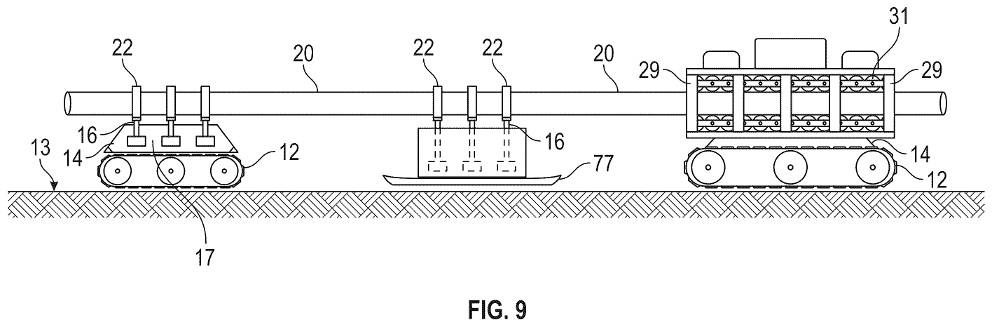

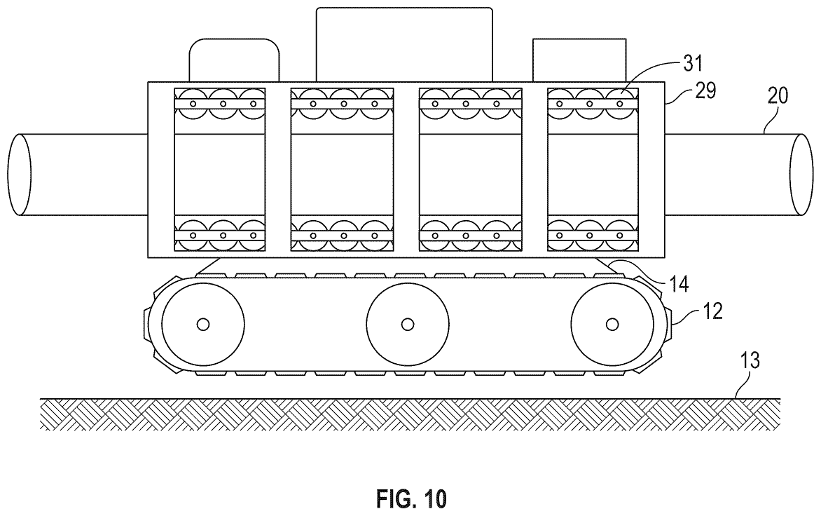

Usually, however, the pipe, pipe segment, or pipe section holder of the apparatus of the invention will receive a pipe, pipe segment, or pipe section 20, directly from a pipe, pipe segment, or pipe section source, as shown for example in FIGS. 21 and 25 and 27 and 28, or similar pipe, pipe segment, or pipe section source, or from another apparatus of the invention, as shown for example in FIGS. 9, 21-26, and 37-40. Transfer of pipe, pipe segment, or pipe sections between apparatuses of the invention do not require or need use of ramp 45 when the apparatuses are positioned in tandem adjacent to one another or in sufficient proximity to one another that the pipe, pipe segment, or pipe section 20 can reach in a transfer from one apparatus to the other without risk of sag.

The apparatus of the invention comprising a mobile unit 14 receives power to be mobile from engine 28. That is, the caterpillar track or tank treads 12, powered by engine 28, provide mobility for the apparatus and its mobile unit 14. Engine 28 can be designed to operate on diesel fuel, gasoline, hydrogen, other green fuels, electrical batteries, solar powered batteries, etc. or any combination thereof.

Controller 32 enables remote operation and control of the apparatus, and can also specifically manage operation of mobile unit 14, engine 28, caterpillar tracks or tank treads 12, support(s) 16, brake 48, and when used, ramp 45. Controller 32 can be remote controlled and can be programmable. Controller 32 is mounted on the apparatus or in electrical communication with these various controllable components of the apparatus. A user can program controller 32 through the use of a remote computer or direct wired computer to operate and manage the apparatus, including the mobile unit 14, engine 32, caterpillar track or tank treads 12, support(s) 16, brake 48, and ramp 45. To manage the aforementioned components means to send signals as desired from a processor to servers or other mechanical component(s) to effect movement in the mobile unit 14, engine 32, caterpillar track or tank treads 12, support(s) 16, brake 48, and when used ramp 45.

In an illustrative example, controller 32 can be programmed to position an apparatus of the invention, or to position a plurality of apparatuses of the invention, for specific parameters of the pipe, pipe segment, or pipe section 20 and the intended pipe, pipe segment, or pipe section line location, such as for example a trench or ditch, or alternatively on a right away or in association with directional underground drilling (such as for pipe, pipe segment, or pipe section line placement under a river or other body of water). That is, for further example, each apparatus can be programmed to move into position based on size and weight of pipe, pipe segment, or pipe section 20, length and depth of the trench or ditch, or number of apparatuses in use in such trench or ditch.

The position of one apparatus of the invention with respect to another apparatus of the invention during operation of laying pipe, pipe segment, or pipe sections at the location for underground installation, particularly in transferring a pipe, pipe segment, or pipe section from one apparatus of the invention to an adjacent apparatus of the invention, is important in order to control sag of the pipe, pipe segment, or pipe section being transported and transferred and to prevent damage to the pipe, pipe segment, or pipe section.

Controller 32 includes antenna 33 which may enable a user to drive the apparatus of the invention, and control the caterpillar tracks or tank treads 12, engine 28, mobile unit 12, support(s) 16, and ramp 45 when used, with a remote controller. Controller 32 can also control signals sent from a level sensor to support(s) 16. In one embodiment, controller 32 can also control signals sent from a level sensor to mobile unit 14 where mobile unit 14 can be raised or lowered or tilted in addition to or instead of raising or lowering support(s) 16.

Controller 32 can be implemented, for example, as custom circuitry, as hardware, a hardware processor executing programmed instructions, a processor implementing software, a processor implementing firmware, or some combination thereof. Dedicated hardware elements may be referred to as “processors,” “controllers,” or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, a control element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

An apparatus of the invention comprising a mobile unit can be used alone and independently of other apparatuses of the invention, or can be used in cooperation with a plurality of like or similar apparatuses of the invention comprising mobile units and/or auxiliary units. An apparatus of the invention can receive, transfer and/or carry or transport, and deliver and unload and/or offload a single pipe, pipe segment, or pipe section, or in cooperation with another adjacent apparatus of the invention in sufficient proximity that a single pipe, pipe segment, or pipe section can extend at least in part over the respective mobile units of both apparatuses and can be supported in at least one pipe holder of at least one of the two apparatuses.

In another use or embodiment of the invention, multiple apparatuses of the invention can be positioned in tandem, end-to-end, in such close proximity that a pipe, pipe segment, or pipe section can be received from one adjacent apparatus and transported or transferred to another adjacent apparatus. In still another embodiment, multiple apparatuses of the invention can be positioned in end-to-end tandem and in such close proximity that a single pipe, pipe segment, or pipe section 20, having multiple pipe, pipe segment, or pipe sections segments or sections welded together, can be carried and transported by those multiple apparatuses working together, as shown for example in FIGS. 21-26, and 36-42.

In all such uses or embodiments of the invention, the apparatuses of the invention maintain the pipe, pipe segment, or pipe section in parallel alignment with the longitudinal central axes 132 of the apparatuses and during receipt, transfer, transport and unloading or offloading of the pipe, pipe segment, or pipe section.

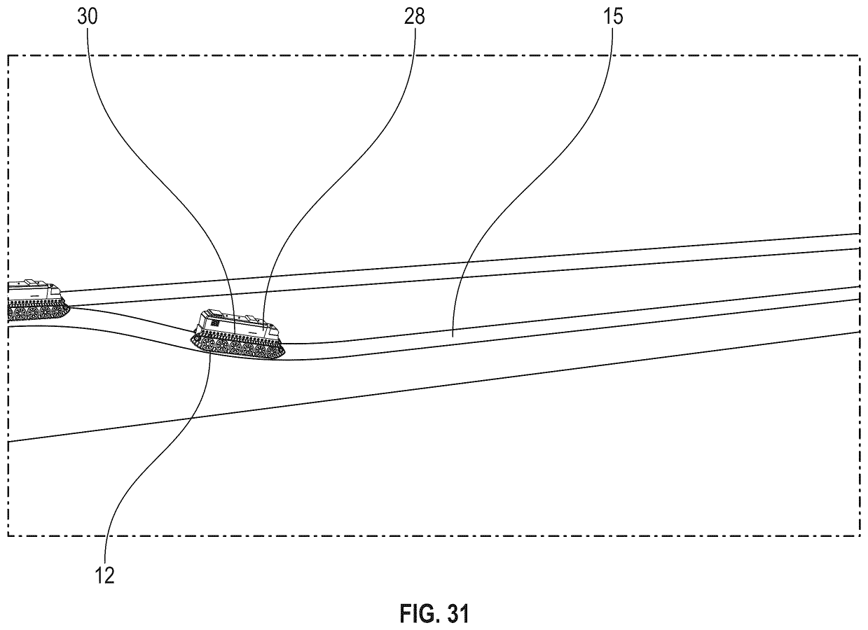

FIGS. 21, 22, 25, 26 and 31-42 illustrate how the ability of the apparatuses of the invention to work together serially in receiving, transferring, transporting and delivering pipe, pipe segment, or pipe section can be effectively used in laying pipe, pipe segment, or pipe section for underground installation. FIGS. 31-42 further illustrate how the apparatuses of the invention take advantage of their small size and their ability to essentially go where a pipe, pipe segment, or pipe section can go—in a trench or ditch cut for placement of a pipe, pipe segment, or pipe section. FIGS. 21, 22, 25, 26 and 31-42 show apparatuses of the invention transporting a pipe, pipe segment, or pipe section 20, from a source of pipe, pipe segment, or pipe section, to a delivery location 65 in a trench or ditch 15 for intended placement of the pipe, pipe segment, or pipe section 20, for comprising a portion of the pipe, pipe segment, or pipe section to be laid in the ditch by cooperating apparatuses of the invention. Any of the embodiments of the apparatus of the invention described herein could be substituted for the apparatuses in these Figures illustrating embodiments of the method of the invention.

Apparatuses 51, 52, and 53 in FIGS. 21 and 22 are positioned in a line relative to each other such that the longitudinal central axis 132 of each is collinear one apparatus with respect to the other apparatus. The apparatuses are shown in a trench or ditch 15 but could just as easily be on a right away or on the side above the ditch or even on a utility roadway, for example. In other words, the apparatuses of the invention are versatile due to their size and structure and can generally move about on a pipe, pipe segment, or pipe section installation site without departing from the established right-or-way or easement for the pipe, pipe segment, or pipe section installation.

As shown in FIG. 21, a first apparatus of the invention 51 receives at one end 44 the initial portion of pipe, pipe segment, or pipe section segment or section 20, from the source 50 of pipe, pipe segment, or pipe section, and transfers this portion of pipe, pipe segment, or pipe section 20 at apparatus 51's other end 44 to adjacent apparatus 52, who receives that first portion of pipe, pipe segment, or pipe section 20 while apparatus 51 receives the second portion of pipe, pipe segment, or pipe section 20. Apparatus 52 then transfers that first portion of pipe, pipe segment, or pipe section 20 to adjacent apparatus 53 while apparatus 52 receives the second portion of pipe, pipe segment, or pipe section 20 and apparatus 51 receives the third and final portion of pipe, pipe segment, or pipe section 20.

With pipe, pipe segment, or pipe section 20 thus fully loaded on apparatuses 51, 52 and 53 and secured in the pipe holders 61, 62, 63, and 57, 58, 59, and 54, 55, 56 on the respective apparatuses 51, 52, and 53, and with said apparatuses having maintained the pipe, pipe segment, or pipe section 20 in alignment with the longitudinal central axes 132 of the apparatuses and their respective mobile units 14 during such receipt and transfer, the apparatuses 51, 52, and 53 in cooperation together transport pipe, pipe segment, or pipe section 20 to the delivery location in the trench 15 while continuing to maintain the pipe, pipe segment, or pipe section 20 in alignment with the longitudinal central axes 132 of the respective apparatuses.

At the delivery location 65 in the trench 15, as shown in FIG. 22, while continuing to maintain the pipe, pipe segment, or pipe section 20 in alignment with the longitudinal central axis 132 of the respective apparatuses, apparatus 51, the most distal to the delivery location in the trench 65, raises the support 16 for the pipe holder 63 and thus raises pipe, pipe segment, or pipe section holder 63 higher than the other pipe holders on any of the three apparatuses. Apparatus 51 also about simultaneously similarly raises the pipe holder 62 to be the next highest and pipe holder 61 to be the next highest. At about the same time, adjacent apparatus 52 similarly raises the pipe holder 59 to be the next highest, and pipe holder 57 to be the next highest, and pipe holder 56 to be the next highest. Also at about the same time, apparatus 53, the most proximal to the delivery location 65 in the trench 15, releases ramp 45 to extend out to delivery location 65 and raises pipe holders 56, 55, and 54 with each raised less than the one before such that pipe holder 54 is raised the least (or not at all) so the pipe holders on the three apparatuses decrease serially and substantially simultaneously in height as they near or after they reach the delivery location 65. This gradual change in the height of the pipe holders causes pipe, pipe segment, or pipe section 20 to be higher at its distal end with respect to the delivery location 65 and gravity urges pipe, pipe segment, or pipe section 20 to begin transfer from apparatus 53 to ramp 45 for unloading off apparatus 53 and to begin transfer from apparatus 52 to apparatus 53 and from apparatus 51 to apparatus 52. Apparatus 51 can move away from apparatus 52 as pipe, pipe segment, or pipe section 20 unloads off apparatus 51. The transfer and movement of pipe, pipe segment, or pipe section 20 continues toward the ramp 45 and apparatus 52 can move away as pipe, pipe segment, or pipe section 20 unloads off apparatus 52. Apparatus 53 similarly can move away as the final portion of pipe, pipe segment, or pipe section 20 unloads off apparatus 53 and the entire pipe, pipe segment, or pipe section 20 is laid at delivery location 65. Throughout the receipt, transfer, transport and delivery, the weight of the pipe, pipe segment, or pipe section 20 is aligned with the longitudinal central axes 132 of the apparatuses supporting it.

The incline for unloading of the pipe, pipe segment, or pipe section should be sufficiently gradual, and the number of apparatuses sufficient for adequate proximity one to another for controlled transfer and delivery of the pipe, pipe segment, or pipe section, so that such transfer and delivery of the pipe, pipe segment, or pipe section occurs without sag and the pipe, pipe segment, or pipe section is otherwise not damaged during the process.

The principals of the method and application of use of the apparatuses described with respect to FIGS. 21 and 22 can be similarly applied for transporting multiple pipes, pipe segments, or pipe sections to a pipe, pipe segment or pipe section holding unit for use in pipe, pipe segment, or pipe section placement at certain locations, such as under a body of water using directional drilling equipment as shown in FIGS. 23 and 24, or for delivering multiple pipes, pipe segments, or pipe sections to a pipe, pipe segment, or pipe section location for connecting pipe, pipe segment, or pipe sections at that location, and avoiding transport of longer pipe, pipe segment, or pipe section sections.

That is, the above described method or procedure illustrated in FIGS. 21 and 22 can be effectively repeated in the method or procedure illustrated in FIGS. 23 and 24, but for delivery and downloading of pipe, pipe segment, or pipe section 20, into a delivery location 67 that is a feed port for using directional drilling for taking and laying pipe, pipe segment, or pipe section under a river 68 rather than the actual surface where the pipe, pipe segment, or pipe section section will be laid for installing the pipe, pipe segment, or pipe section underground.

Referring to FIGS. 23 and 24, apparatuses 51, 52, and 53 again work in tandem to deliver pipe, pipe segment, or pipe section 20 to the delivery location 67. Pipe, pipe segment, or pipe section 20 is then welded to another pipe, pipe segment, or pipe section 20 to be taken under the river 68 where both pipes, pipe segment, or pipe sections 20 will be taken by carrier pipe 76, which is being pulled underground under the bottom of the river 75 by drilling rig 70 and placed under that bottom of the river 75 to connect to the pipe, pipe segment, or pipe section on the opposing side of the river. More than two pipes, pipe segments or pipe sections 20 may be needed for that connection, depending on the width and depth of the river 68, but the pipes, pipe segments or pipe sections should be connected together before being taken by carrier pipe 76 underground under the bottom of the river 75. The carrier pipe 76 and the pipe, pipe segment, or pipe section 20 are preceded by a cutter/shaver 71, a swivel 72, a reamer 74, and a guide 73, also all pulled by the drilling rig 70, to make, secure, and lubricate the hole for pulling and placement of the pipe, pipe segment, or pipe section 20 under the river 68.

In another embodiment of this method, apparatuses of this invention are also used to first deliver pipe, pipe segment, or pipe section 20 to a pipe, pipe segment, or pipe section storage unit near the delivery location 67. From this pipe, pipe segment, or pipe section storage unit, the pipe, pipe segment, or pipe section 20 can be connected to another pipe, pipe segment, or pipe section 20 and then loaded onto apparatuses of the invention. The apparatuses then transport and deliver the pipe, pipe segment, or pipe section to the delivery location 67 as above described.

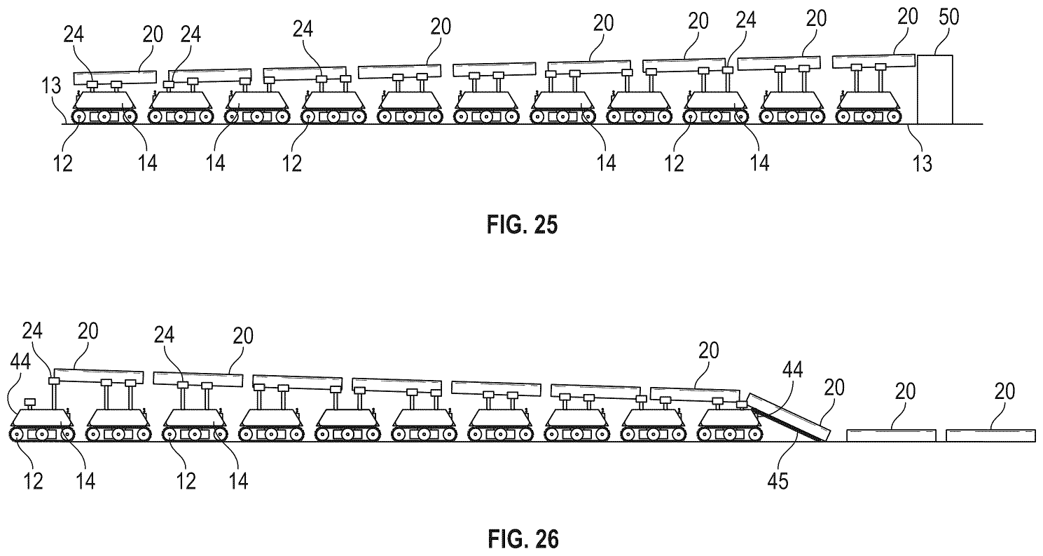

While these FIGS. 21-24 illustrate cooperative use of three apparatuses of the invention for transport and delivery of a single pipe, pipe segment, or pipe section, the principal of operation is similarly effective for multiple pipes, pipe segments, or pipe sections, as illustrated in FIGS. 25-43. Further, such cooperation can be accomplished with each apparatus carrying its own load (as in FIGS. 25-26), rather than sharing a load (as in FIGS. 27-43), and each transferring its load to the adjacent apparatus for delivery of a number of pipe, pipe segment, or pipe sections in series or in sequence. Such illustrations are but examples of the physical implementations for a plurality of apparatuses of the invention, including any of the embodiments illustrated herein, particularly with respect to transporting and laying pipe, pipe segment, or pipe sections for underground installation.

Although three apparatuses are depicted in the examples of FIGS. 21 and 22, and FIGS. 23 and 24, the number of apparatuses needed for transporting and laying pipe, pipe segment, or pipe section for underground installation is determined by the number of pipe, pipe segment, or pipe sections to be delivered, the dimensions of the pipe, pipe segment, or pipe section, and the type/intended use of the pipe, pipe segment, or pipe section. Additional or fewer apparatuses can be used, including without limitation for uses such as the ones discussed above and illustrated in FIGS. 6 and 7 and 8 and 9.

FIGS. 25 and 26 illustrate another embodiment of the method of the invention employing a plurality of apparatuses of the invention for transporting multiple pipes, pipe segments, or pipe sections 20 for underground installation. In this embodiment, a plurality of pipe, pipe segment, or pipe section laying apparatuses of the invention are positioned in a line, end to end (i.e., tandem), at a source for or feeder 50 of pipe, pipe segment, or pipe section 20. As with many embodiments of the invention, each apparatus of the invention is weighted and configured to carry one pipe, pipe segment, or pipe section 20.

In FIGS. 25 and 26, the first apparatus, that is, the apparatus most proximate the pipe, pipe segment, or pipe section source 50 receives from that source 50 a first pipe, pipe segment, or pipe section 20 onto the pipe holders on the supports 16 on the mobile unit 14 of that first apparatus.

This first apparatus then transfers that first pipe, pipe segment, or pipe section from said mobile unit to the mobile unit of a second apparatus adjacent to said first apparatus, while accepting or receiving a second pipe, pipe segment, or pipe section 20 from the pipe, pipe segment, or pipe section source 50. The second apparatus transfers the first pipe, pipe segment, or pipe section 20 to a third apparatus adjacent the second apparatus and distal the first apparatus, while the first apparatus transfers the second pipe, pipe segment, or pipe section 20 to the second apparatus and the first apparatus receives a fourth pipe, pipe segment, or pipe section 20 from the pipe, pipe segment, or pipe section source 50. The apparatuses in the line continue to receive and reciprocally transfer pipe, pipe segment, or pipe section 20 down the line until all the apparatuses in the line are holding a pipe, pipe segment, or pipe section 20, including the apparatus most distal the pipe, pipe segment, or pipe section source 50, as shown in FIG. 25.

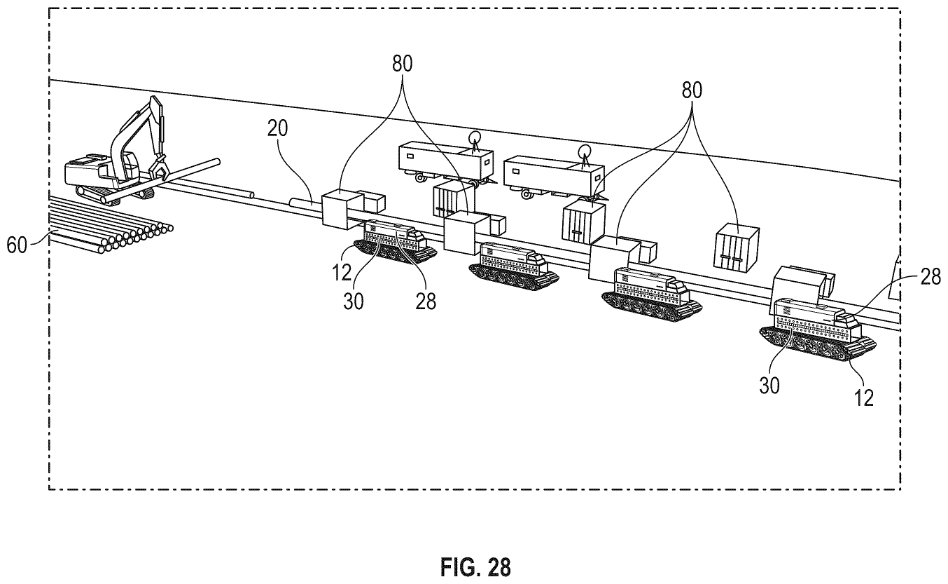

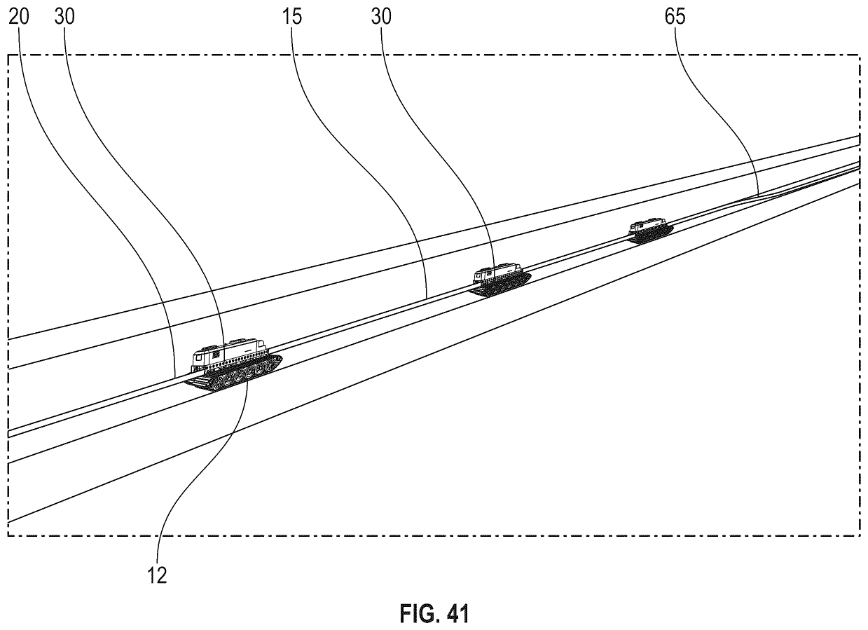

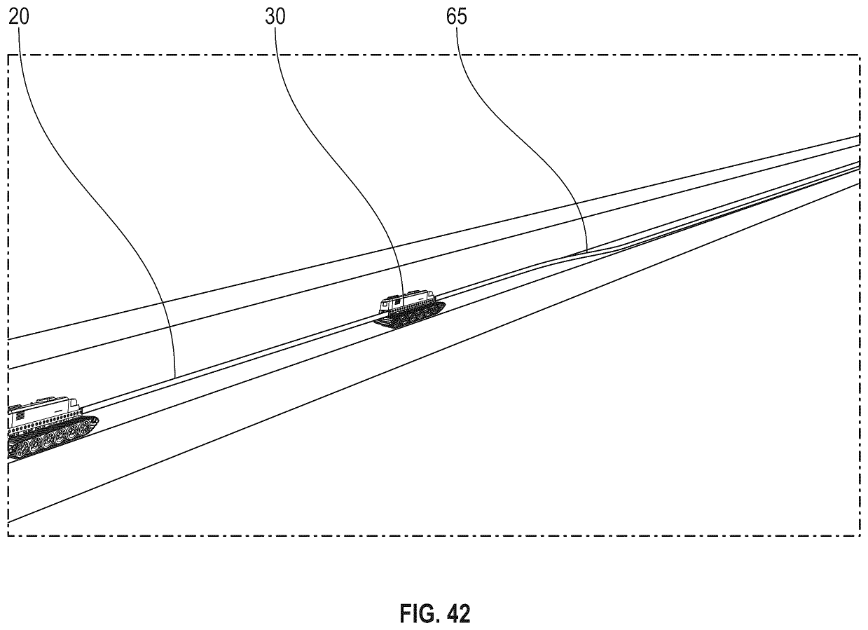

Once loaded with pipe, pipe segment, or pipe section 20, the apparatuses in line move in tandem to the location for delivering and laying the pipe, pipe segment, or pipe section 20, which is typically a pipe, pipe segment, or pipe section holding unit near the site the pipe, pipe segment, or pipe section is to be laid (such as delivery location 60 in FIGS. 27 and 28) and installed underground, or the pipe, pipe segment, or pipe section site itself (such as pipeline assembly stations 80 in FIGS. 41 and 42), where the pipe, pipe segment, or pipe section 20 will be connected to other pipe, pipe segment, or pipe section 20 for placement and underground installation.

As shown in FIG. 26, at the location for delivering and laying the pipe, pipe segment, or pipe section 20, each apparatus again arranges in a line, end to end. The apparatus on the end of the line most proximal the location for delivering and laying the pipe, pipe segment, or pipe section 20 then extends or attaches ramp 45 at its end 44 most proximal the location for delivery and moves the pipe, pipe segment, or pipe section 20 it is carrying down ramp 45 to unload the pipe, pipe segment, or pipe section 20 at that delivery location.

About the same time, the apparatus adjacent this most proximal apparatus causes the pipe, pipe segment, or pipe section 20 it is carrying to offload to that most proximal apparatus, which in turn moves that pipe, pipe segment, or pipe section 20 down the ramp 45. Also at about the same time, each apparatus in line reciprocates, moving its pipe, pipe segment, or pipe section 20 forward toward the adjacent apparatus in the direction of the most proximal apparatus causing said most proximal apparatus to continue to unload each pipe, pipe segment, or pipe section 20 down the ramp 45 for deposit at the delivery location. Once the apparatus at the distal end of the line is no longer holding a pipe, pipe segment, or pipe section 20, as that apparatus is not positioned in the direction to receive a pipe, pipe segment, or pipe section 20 from an adjacent apparatus, the apparatus leaves the line.

Once said pipe, pipe segment, or pipe section on the apparatuses have been delivered or laid for underground installation, the apparatuses return to the pipe, pipe segment, or pipe section source 50 to repeat these steps until the pipe, pipe segment, or pipe section 20 delivery desired for the underground installation is complete.

FIGS. 27-43 illustrate a similar embodiment of the method of the invention as described as illustrated in FIGS. 25 and 26. Again, instead of lowering pipe segments for the pipeline into the trench from the right-of-way as in prior art methods, the method of the invention uses multiple apparatuses of the invention positioned in tandem to move down into the trench 15 to lay the pipes, or pipe segments, or pipe sections 20 for installation of the pipeline in place and ultimately underground. FIGS. 27-30 show that the site is staged at the beginning of the trench 15 to completely assemble pipe segments on a conveyor driven assembly-line of stations 80 that are set up for each stage of the pipeline assembly process. Multiple apparatuses of the invention are lined up along the assembly line of stations 80 in preparation for receiving the pipe segments or pipe sections from the last station in the assembly line and carrying the pipe segments or pipe sections to the trench 15 for laying the pipeline.

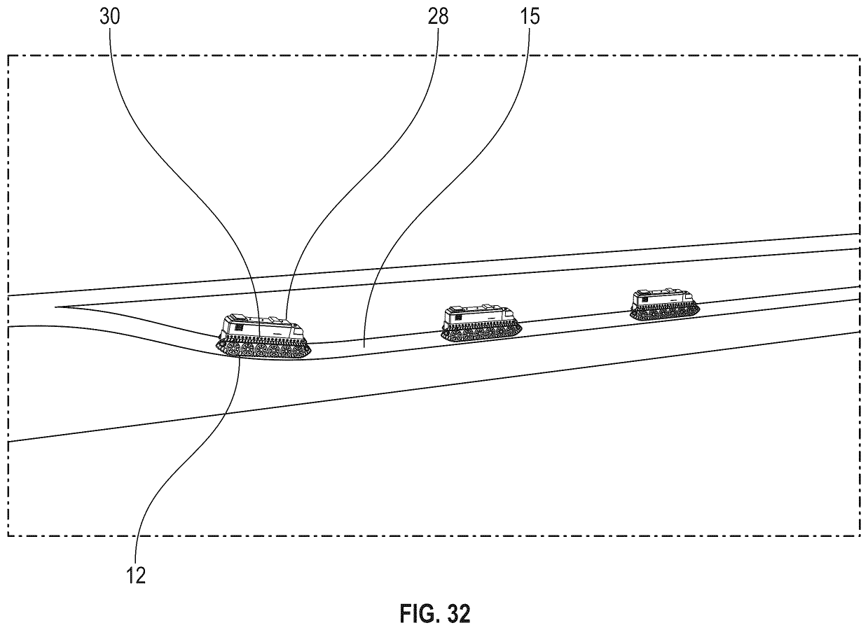

After the pipe segments are pushed through the stations 80, they travel through each of the apparatuses that are waiting in the trench 15 to guide the pipe segments into position, as shown in FIGS. 32-42. Once the pipe segments are in position, that is laid in the trench 15, the apparatuses of the invention slide out from the pipe segments. That is, the pipe segments are gently lowered into the trench 15 as the apparatuses of the invention move out of it (as described above in more detail in discussing the method illustrated in FIGS. 25 and 26.

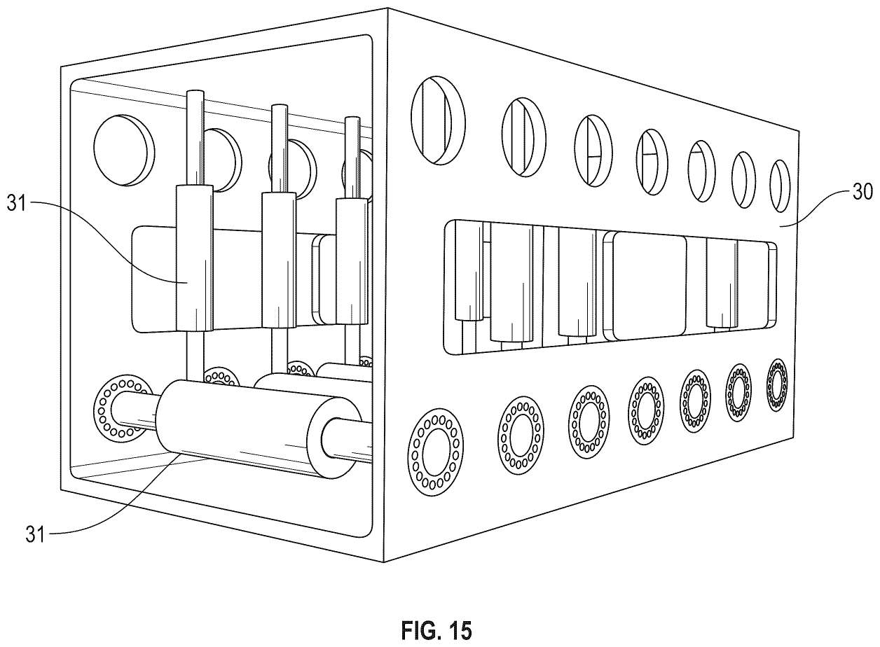

In the embodiment of the method of the invention shown in FIGS. 27-43, the apparatuses of the invention are like those shown in FIGS. 12-14, that use pre-programmed, hydraulically powered, cage pipe holders 30 with longitudinal or cylindrical rollers 31, as shown in FIGS. 15-18. Once the pipe segments have been lowered into place, the site equipment, i.e., assembly line of stations 80, as shown in FIGS. 27-30 and FIG. 43, and the apparatuses of the invention are moved to the next section of trench dug or to be dug for further laying of pipe segments for underground installation, and the described method is repeated to extend the pipeline further.

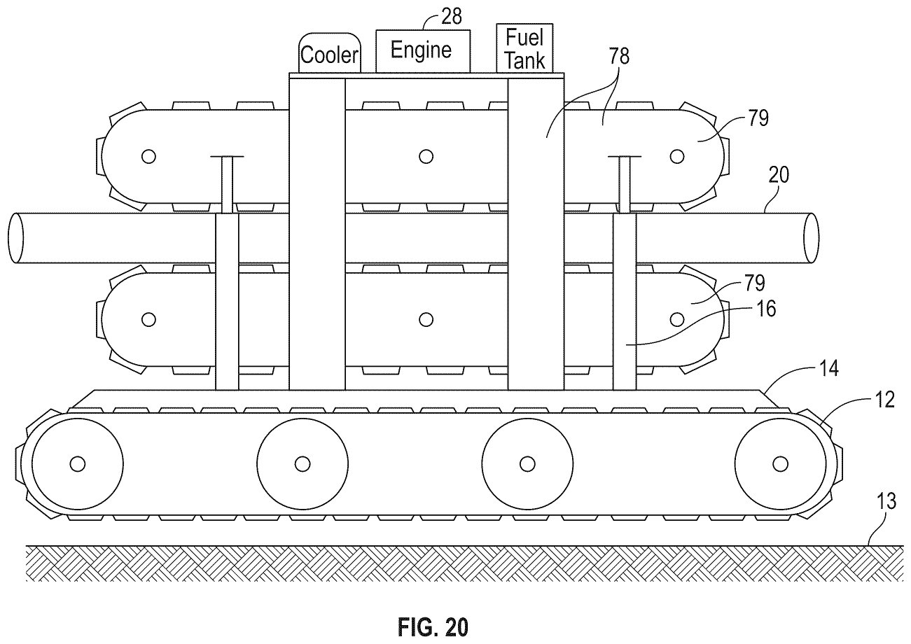

FIG. 9 is a schematic of three apparatuses of the invention that can be used in tandem with each other in various configurations in methods of the invention, that is, with several of one adjacent in line and then another in line, rather than exactly as or substantially similar to one and then the other and then the third one as shown in FIGS. 20-26 for example. In this FIG. 9, the second or middle apparatus differs from the first and third apparatuses shown in that the second or middle apparatus is not independently maneuverable, i.e., it has no battery or engine for movement but rather is pulled or pushed along by the first apparatus and/or the third apparatus. This second or middle apparatus (similar to the apparatus in FIG. 19), thus has a sled base 77 to make it easier to push and/or pull. The apparatus still has pipe, pipe segment, or pipe section holders 22 (for example) that can be raised or lowered so as to support and facilitate receiving, transport and delivery of pipe, pipe segment, or pipe section 20. This “dummy” embodiment in FIGS. 9 and 19 thus can work in tandem with the other embodiments of the apparatus of the invention and can life and lower and carry pipe or cable just as the other embodiments of the apparatus of the invention can, except that this dummy embodiment cannot itself move forward or backward independently to transport pipe or cable.

The first apparatus shown in FIG. 9 is similar to the embodiment shown in FIG. 5 and the third apparatus shown in FIG. 9 is similar to the apparatus shown in FIG. 10, discussed above. FIG. 9 is but one example of the many various configurations possible with the apparatuses and methods of the invention, depending on the needs possibly dictated by the terrain and location to which the pipe, pipe segment, or pipe section is to be laid, among other factors such as costs, timing and availability of various apparatuses.

Similarly, many more variations or embodiments of the apparatus of the invention can be contemplated with similar or even identical functionality as described for the illustrative embodiments discussed herein. One such further alternative embodiment is shown in FIG. 20, which can be used in any of the embodiments of the method of the invention described herein in addition to or instead of the embodiments of the apparatuses shown in the illustrations discussed.

The embodiment of the apparatus of the invention in FIG. 20 has a caterpillar or tank treads 12, a mobile unit 14, supports 16, and a tensioner-style pipe holder 78 comprised of a pair of parallel and overlying rollable treads or tread-type rollers 79 for holding pipe, pipe segment, or pipe section by sandwiching it between the rollable treads or tread-type rollers 79. At least one of the rollable treads or tread-type rollers in the pair 79 can be raised or lowered with respect to the other rollable tread or tread-type rollers in the pair 79, so that the distance between the rollable treads or tread-type rollers of the pair 79 accommodates pipe, pipe segment, or pipe section having various diameters. The rollable treads or tread-type rollers 79, when not rolling, can thus hold the pipe, pipe segment, or pipe section 20 for transport, and can roll for receiving and offloading or unloading pipe, pipe segment, or pipe section 20 to facilitate such receiving and offloading or unloading by the push or pull of the pipe, pipe segment, or pipe section caused by the rolling of the roller treads or tread-type rollers 79. This embodiment of the apparatus of the invention thus has all of the uses in the embodiments of the method of the invention as the other embodiments of the apparatus of the invention described above.

The description of the different illustrative embodiments of the present invention has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the invention, the practical application, and to enable persons of ordinary skill in the art to understand the disclosure for various embodiments with various modifications as are suited to the particular use contemplated.

### APPENDIX LIST OF ELEMENTS IN DRAWINGS

12 Caterpillar tracks or tank treads
13 Soil
14 Mobile unit
15 Trench or ditch
16 Support
17 Lateral side of mobile unit
18 Dug-out soil on right of way of trench or ditch
19 Encasing pipe holder
20 Pipe, pipe segment, or pipe section
21 Rollers
22 O-shaped pipe holder
23 Rollers
24 C-shaped pipe holder
25 Horseshoe shaped pipe holder
26 Gantry
27 Rollers
28 Engine
29 Cage pipe holder with rollers on all internal sides (top, bottom, and both lateral sides) of the cage.
30 Cage pipe holder with rollers on the bottom and both lateral sides of the interior of the cage, but not on the top interior side of the cage.
31 Longitudinal or cylindrical rollers
32 Controller
33 Antenna associated with controller
Connectors for attaching longitudinal or cylindrical rollers to cage pipe holder
38 Brake
44 End (interchangeable front end or back end of apparatus and mobile unit of the apparatus)
45 Ramp
46 Rollers on ramp
47 Wheel on ramp
50 Pipe, pipe segment, or pipe section source
51 One embodiment of an apparatus of the invention
52 One embodiment of an apparatus of the invention like apparatus 51
53 One embodiment of an apparatus of the invention like apparatus 51
54 One embodiment of a pipe holder on apparatus 53
55 One embodiment of a pipe holder on apparatus 53, like pipe holder 54
56 One embodiment of a pipe holder on apparatus 53, like pipe holder 54
57 One embodiment of a pipe holder on apparatus 52, like pipe holder 54
58 One embodiment of a pipe holder on apparatus 52, like pipe holder 54
59 One embodiment of a pipe holder on apparatus 52, like pipe holder 54
60 Delivery location
61 One embodiment of a pipe holder on apparatus 51, like pipe holder 54
62 One embodiment of a pipe holder on apparatus 51, like pipe holder 54
63 One embodiment of a pipe holder on apparatus 51, like pipe holder 54
65 Delivery location in trench for pipe, pipe segment, or pipe section placement
67 Delivery location at river for pipe, pipe segment, or pipe section
68 River
69 Drill pipe
70 Drilling rig
71 Cutter/shaver
72 Swivel
73 Guide
74 Reamer
75 River bottom
76 Carrier pipe
77 Sled or skid
78 Tensioner style pipe holder
79 Pair of parallel and overlying rollable treads or tread-type rollers for the tensioner-style pipe holder 78
80 Pipeline assembly stations
112 Weight of pipe, pipe segment, or pipe section
132 Longitudinal central axis of apparatus of invention

What is claimed is:

1. A pipe, pipe segment, or pipe section transporting and laying apparatus for transporting and laying at a delivery location a pipe, pipe segment, or pipe section for underground installation, comprising:
(a) a mobile unit having a longitudinal central axis and a front end and a rear end for receiving and unloading the pipe, pipe segment, or pipe section onto and off of the mobile unit, wherein said front end and said rear end can be used interchangeably;
(b) at least one support configured to align a weight of the pipe, pipe segment, or pipe section with said longitudinal central axis upon receiving, holding, transporting and unloading the pipe, pipe segment, or pipe section at said delivery location;
(c) at least one pipe holder with a low-friction surface extending from or associated with said at least one support for facilitating said receiving, holding, transporting and unloading of said pipe, pipe segment, or pipe section at said delivery location, wherein said pipe holder comprises:
(i) a casing-type encasement-type pipe holder which surrounds the external diameter of said pipe, pipe segment, or pipe section with rollers for at least a portion of the length of said pipe, pipe segment, or pipe section;
(ii) a cage type encasement-type holder;
(iii) a C-shaped cradle-type holder;
(iv) a horseshoe-shaped encasement-type holder extending from at least one gantry;
(v) an O-shaped holder;
(vi) a D-shaped cradle-type holder; or
(vii) a tensor-type holder having a pair of overlying roller treads or tread-type roller;
(d) caterpillar track or tank treads, wheels, skids, or sled to carry and move said apparatus;
(e) an engine or motor configured to drive said caterpillar track or tank treads, wheels or sled or skids; and
(f) a programmable controller for controlling movement of said apparatus remotely.

2. The apparatus of claim 1 wherein the footprint of said apparatus is no more than six inches greater than the diameter of the pipe, pipe segment, or pipe section the apparatus carries.

3. The apparatus of claim 1 further comprising:
an optional ramp for attaching to said front end or said back end of said mobile unit to aid the uploading or unloading of the pipe, pipe segment, or pipe section.

4. The apparatus of claim 1 wherein at least a length of at least one support is adjustable such that a height position of the at least one support or the at least one pipe, pipe segment, or pipe section holder relative to the mobile unit is adjustable.

5. The apparatus of claim 1 wherein said low-friction surface of said pipe, pipe segment, or pipe section holder comprises rollers positioned to be adjacent at least a portion of said pipe, pipe segment, or pipe section to be held in said holder.

6. The apparatus of claim 1 wherein said caterpillar track or tank treads comprise natural or synthetic rubber on their surface contacting soil in use.

7. The apparatus of claim 1 wherein said mobile platform is extensible.

8. The apparatus of claim 1 further comprising an associated auxiliary engineless vehicle which said apparatus pulls or pushes for holding and transporting pipe, pipe segment, or pipe section, wherein said auxiliary engineless vehicle comprises:
a mobile unit having a longitudinal central axis and a front end and a rear end for receiving and unloading pipe, pipe segment, or pipe section onto and off of the mobile unit, wherein said front end and said rear end can be used interchangeably;
at least one support configured to align a weight of the pipe, pipe segment, or pipe section with said longitudinal central axis upon receiving, holding, transporting and unloading the pipe, pipe segment, or pipe section at said delivery location;
at least one pipe, pipe segment, or pipe section holder with a low-friction surface extending from or associated with said at least one support for facilitating receiving from said apparatus and holding, transporting and unloading of said pipe, pipe segment, or pipe section;
sled, skids, wheels, or caterpillar track or tank treads to carry and move said auxiliary engineless vehicle when pushed or pulled by said apparatus.

9. A method of transporting a pipe, pipe segment, or pipe section and laying a pipe, pipe segment, or pipe section for underground installation at a delivery location using more than one apparatus of claim 1, alike or different from one another, and acting in cooperation one with the other, the method comprising:
positioning said more than one apparatus in a line relative to each other in tandem, end to end formation, such that the longitudinal central axis of each is collinear one apparatus with respect to the other apparatus(es), and in sufficient proximity one to the other such that said pipe, pipe segment, or pipe section can extend from said one apparatus to at least said one other of said apparatus(es) such that said pipe, pipe segment, or pipe section does not sag between the apparatuses and such that said pipe, pipe segment, or pipe section is supported by at least one pipe holder on at least one support on the unit of each said one apparatus and at least said one other of said apparatus(es), while allowing said apparatuses sufficient distance between one another that they can each move without hitting the other, and then placing said pipe, pipe segment, or pipe section on said apparatuses accordingly;
moving said apparatuses toward said delivery location;
unloading said pipe, pipe segment, or pipe section at said delivery location by unloading the portion of said pipe, pipe segment, or pipe section on one apparatus while that said one apparatus receives the adjacent portion of said pipe, pipe segment, or pipe section offloaded from said adjacent apparatus, and repeating said transfer of any other portions of said pipe, pipe segment, or pipe section on any other of said apparatuses until the pipe, pipe segment, or pipe section is completely delivered at said delivery location.

10. The method of claim 9 wherein said delivery location is in the floor of a trench or ditch.

11. The method of claim 9 wherein said delivery location is at the mouth of a feed hole for introducing the pipe, pipe segment, or pipe section for placement underground using carrier pipe and a drilling rig.

12. A method of transporting a pipe, pipe segment, or pipe section and laying a pipe, pipe segment, or pipe section in a trench for underground pipeline installation using a plurality of apparatuses of claim 1, which are alike or different one from the other, the method comprising:
(a) positioning at least a first apparatus, a second apparatus and a third apparatus from said plurality of apparatuses in a line relative to each other in tandem such that the longitudinal central axis of each is collinear one apparatus with respect to the other apparatus, adjacent at least one station for preparing at least in part said pipe, pipe segment or pipe section for pipeline installation;
(b) the first of said apparatuses in said line receiving from at least one station a first pipe, pipe segment, or pipe section, onto at least one pipe holder on at least one support on the mobile platform of said first of said apparatuses, while aligning and maintaining alignment of a weight of the pipe, pipe segment or pipe section, with said longitudinal central axis of said first of said apparatuses;
(c) said first of said apparatuses transferring said first pipe, pipe segment, or pipe section, to the second of said apparatuses in said line adjacent to said first apparatus, said second of said apparatuses receiving said first pipe, pipe segment, or pipe section onto at least one pipe holder on at least one support on the mobile platform of said second of said apparatuses, while aligning and maintaining alignment of a weight of pipe, pipe segment, or pipe section, with said longitudinal central axis of said second of said apparatuses, while said first of said apparatuses receives a second pipe, pipe segment, or pipe section onto at least one cable or conduit holder on at least one support on the mobile platform of said first of said apparatuses, while aligning and maintaining alignment of a weight of the pipe, pipe segment, or pipe section with said longitudinal central axis of said first of said apparatuses;
(d) said second of said apparatuses transferring said first pipe, pipe segment, or pipe section, to the third of said apparatuses in said line adjacent to said second apparatus, said third of said apparatuses receiving said first pipe, pipe segment, or pipe section onto at least one pipe holder on at least one support on the mobile platform of said third of said apparatuses, while aligning and maintaining alignment of a weight of the pipe, pipe segment, or pipe section, with said longitudinal central axis of said third of said apparatuses, while said second of said apparatuses receives a second pipe, pipe segment, or pipe section, onto at least one pipe holder on at least one support on the mobile platform of said second of said apparatuses, while aligning and maintaining alignment of a weight of the pipe, pipe segment, or pipe section, with said longitudinal central axis of said second of said apparatuses; while said first of said apparatuses receives a third pipe, pipe segment, or pipe section, onto at least one pipe, pipe segment, or pipe section holder on at least one support on the mobile platform of said first of said apparatuses, while aligning and maintaining alignment of a weight of pipe, pipe segment, or pipe section, with said longitudinal central axis of said first of said apparatuses, while aligning and maintaining alignment of a weight of the pipe, pipe segment, or pipe section, with said longitudinal central axis of said first of said apparatuses;
(e) continuing the reciprocal receiving and transferring of additional pipe, pipe segment, or pipe section, of steps (b)-(d) among or along the line of the plurality of apparatuses until each of said apparatuses is holding a pipe, pipe segment, or pipe section, or pipe, pipe segment, or pipe section segment or section;
(f) moving said line of the plurality of apparatuses toward the delivery location, with each said apparatus maintaining alignment of a weight of the pipe, pipe segment, or pipe section, it is carrying with said longitudinal central axis of that apparatus;
(g) upon the plurality of apparatuses arriving at the delivery location, positioning said apparatuses in line relative to each other in tandem such that the longitudinal central axis of each is collinear one apparatus with respect to the other apparatus;
(h) having the apparatus most proximal the delivery location unload the pipe, pipe segment, or pipe section, on its mobile platform at the delivery location, while receiving from the next most proximal and adjacent apparatus the pipe, pipe segment, or pipe section, on its mobile platform;
(i) continuing said transfer of pipe, pipe segment, or pipe section, from each apparatus to an adjacent apparatus in the line of plurality of apparatuses with said most proximal apparatus unloading each upon receipt at the delivery location until said most proximal apparatus has unloaded at said delivery location all pipe, pipe segment, or pipe section, that were carried by the plurality of apparatuses.
